(19) United States
(12) Patent Application Publication
(10) Pub. No.: US 2017/0366435 A1
(43) Pub. Date: Dec. 21, 2017

(54) AVAILABLE BANDWIDTH MEASURING SYSTEM, AVAILABLE BANDWIDTH MEASURING METHOD, TRANSMISSION SIDE DEVICE, RECEIVING SIDE DEVICE, STORAGE MEDIUM STORING TRANSMISSION SIDE DEVICE CONTROL PROGRAM AND STORAGE MEDIUM STORING RECEIVING SIDE DEVICE CONTROL PROGRAM

(71) Applicant: NEC CORPORATION, Tokyo (JP)

(72) Inventor: Takashi OSHIBA, Tokyo (JP)

(73) Assignee: NEC CORPORATION, Tokyo (JP)

(21) Appl. No.: 15/545,033

(22) PCT Filed: Jan. 15, 2016
(86) PCT No.: PCT/JP2016/000203

§ 371 Date: Jul. 20, 2017

(30) Foreign Application Priority Data
Jan. 20, 2015 (JP) 2015-008234

(51) Int. Cl. H04L 12/26

(52) U.S. Cl. CPC H04L 43/0882; H04L 43/10; H04L 43/026; H04L 43/04; H04L 43/12

(57) ABSTRACT

[Problem] To provide an available bandwidth measuring method capable of appropriately changing a search range of available bandwidths and improving the accuracy of available bandwidths. [Solution] The present invention is characterized by setting a first search range provided with a first determination section that determines whether or not the first search range for searching available bandwidths is to be changed to a second search range, generating a packet train containing a plurality of measurement packets having packet sizes that increase sequentially on the basis of the first search range, transmitting the plurality of measurement packets at a predetermined transmission interval, receiving the packet train and measuring a reception interval of the plurality of measurement packets, calculating and outputting estimated values of available bandwidths on the basis of the result of measuring the reception interval and packet sizes of the plurality of measurement packets, determining whether or not to change from the first search range to the second search range on the basis of the first determination section and the estimated values, and on the basis of the determination result, setting a change to the second search range and continuing the search for available bandwidths, or determining available bandwidths using the estimated values as available bandwidths.

### TECHNICAL FIELD

The present invention relates to an available bandwidth measuring system, an available bandwidth measuring method, a transmission side device, a receiving side device, a storage medium storing a transmission side device control program, and a storage medium storing a receiving side device control program.

### BACKGROUND ART

Various types of content information have been recently communicated through communication lines constituting the Internet, a public network, and the like. The content information includes information premised on securing a predetermined communication rate in accordance with details of the content, and information not permitting delay. Accordingly, measurement of a usable bandwidth of a communication line (hereinafter referred to as an available bandwidth) is important for securing transmission quality of content information.

For example, in a case of communication of content information related to a video image, a transmission rate needs to be held down below an estimated value of an available bandwidth. Accordingly, in order to prevent a total of a transmission rate of content information and a transmission rate of another type of traffic (hereinafter referred to as cross traffic) flowing through a communication line from exceeding a physical bandwidth of a bottleneck link in the communication line, a coding rate of a video image is increased in the content information to hold down the transmission rate, in accordance with a measured available bandwidth. Consequently, packet loss of content information related to a video image is suppressed, and therefore interruption of the video image reproduced in accordance with the content information is suppressed.

Note that the available bandwidth represents a free bandwidth obtained by subtracting a transmission rate of cross traffic flowing through a communication line from a physical bandwidth of a bottleneck link in the communication line. For example, when a physical bandwidth of a bottleneck link of a communication line is 100 mega-bits per second (Mbps), and a transmission rate of cross traffic is 30 Mbps, an available bandwidth becomes 100 Mbps−30 Mbps=70 Mbps.

PTL 1 discloses a method of measuring an available bandwidth by using a packet train including a plurality of packets with successively varied packet sizes. Specifically, in a technology described in PTL 1, each reception interval related to a transmission interval of each packet in a packet train is measured. An estimated value of an available bandwidth is calculated from a packet size when a measured reception interval starts to extend with respect to a transmission interval, and the reception interval. In the technology described in PTL 1, an estimated value of an available bandwidth estimated from a packet size of a maximum packet out of packets measured reception intervals of which being equivalent to transmission intervals of the respective packets, and the reception interval, is determined to be the available bandwidth.

PTL 2 discloses a method of transmitting a plurality of transmission packets from the transmission side and determining a network characteristic between the transmission side and the receiving side. Specifically, in a technology described in PTL 2, the transmission side transmits a plurality of transmission packets and receives, from the receiving side, reception packets responding to reception of the respective transmission packets. In the technology described in PTL 2, a plurality of transmission packets are paired with a plurality of reception packets transmitted in response thereto, and a time between transmission of a transmission packet and reception of a pairing reception packet (hereinafter referred to as a round trip time) is measured. In the technology described in PTL 2, an available bandwidth is determined in accordance with a measured round trip time.

### CITATION LIST

### Patent Literature

PTL 1: Japanese Unexamined Patent Application Publication No. 2011-142622 (pp. 8 to 13, FIGS. 1 and 4)

PTL 2: Japanese Unexamined Patent Application Publication No. 2002-199009 (pp. 3 to 5, FIG. 3)

### SUMMARY OF INVENTION

### Technical Problem

In the technology described in PTL 1, a plurality of packets having successively increasing packet sizes and being included in a packet train used for measurement of an available bandwidth are transmitted at predetermined intervals. Accordingly, in the technology described in PTL 1, a search range of an available bandwidth is limited by packet sizes and predetermined transmission intervals of a plurality of packets included in a packet train used for measurement. In other words, the technology described in PTL 1 has a problem that an available bandwidth cannot be properly estimated when a true value of the available bandwidth exists outside a search range covered by a packet train.

In the technology described in PTL 2, a round trip time between transmission of a transmission packet from the transmission side and reception of a reception packet, being transmitted from the receiving side in response to the transmission packet, by the transmission side, is measured, and an available bandwidth is determined. Accordingly, it is assumed in the technology described in PTL 2 that a communication line from the receiving side transmitting a reception packet to the transmission side is not congested in determination of an available bandwidth between the transmission side and the receiving side. Consequently, since a round trip time is measured in the technology described in PTL 2, an available bandwidth related to availability of a line from the transmission side to the receiving side is not determined when the line from the transmission side to the receiving side is available while a line from the receiving side to the transmission side is congested. In other words, the technology described in PTL 2 has a problem that there is a risk of determining an incorrect available bandwidth reflecting a congestion state of a line from the receiving side to the transmission side, in accordance with a measured round trip time.

Thus, the technologies described in PTLs 1 and 2 have a problem that a search range is limited and an available bandwidth cannot be properly measured.

An object of the present invention is to provide an available bandwidth measuring system, an available bandwidth measuring method, a transmission side device, a receiving side device, a storage medium storing a transmission side device control program, and a storage medium storing a receiving side device control program that are able to improve precision of an available bandwidth by properly changing a search range of the available bandwidth.

### Solution to Problem

An available bandwidth measuring system, according to the present invention, comprises:

search range setting means to which a first search range provided with a first determination section determining whether or not to change the first search range searched for an available bandwidth to a second search range is set;

packet transmission means that generates a packet train including a plurality of measurement packets having successively increasing packet sizes, in accordance with the first search range, and transmits the plurality of measurement packets at predetermined transmission intervals;

reception interval measurement means that receives the packet train and measures reception intervals of the plurality of measurement packets;

estimated value calculation means that calculates an estimated value of the available bandwidth in accordance with the packet sizes and a measurement result of the reception intervals of the plurality of measurement packets, and outputs the estimated value; and

determination means that
determines whether or not to change the first search range to the second search range, in accordance with the first determination section and the estimated value, and,
in accordance with a determination result,
sets a change to the second search range, to the search range setting means, and continue searching for the available bandwidth, or
makes an available bandwidth determination of determining the estimated value to be the available bandwidth.

An available bandwidth measuring method, according to the present invention, comprises:

setting a first search range provided with a first determination section determining whether or not to change the first search range searched for an available bandwidth to a second search range;

generating a packet train including a plurality of measurement packets having successively increasing packet sizes, in accordance with the first search range, and transmitting the plurality of measurement packets at predetermined transmission intervals;

receiving the packet train and measuring reception intervals of the plurality of measurement packets;

calculating an estimated value of the available bandwidth in accordance with the packet sizes and a measurement result of the reception intervals of the plurality of measurement packets, and outputting the estimated value; and

determining whether or not to change the first search range to the second search range, in accordance with the first determination section and the estimated value, and, in accordance with a determination result, setting a change to the second search range and continuing searching for the available bandwidth, or making an available bandwidth determination of determining the estimated value to be the available bandwidth.

A transmission side device, according to the present invention, comprises:

search range setting means to which a first search range provided with a first determination section determining whether or not to change the first search range searched for an available bandwidth to a second search range is set;

packet transmission means that generates a packet train including a plurality of measurement packets having successively increasing packet sizes, in accordance with the first search range, and transmits the plurality of measurement packets at predetermined transmission intervals; and

determination means that
receives the packet train,
measures reception intervals of the plurality of measurement packets,
calculates an estimated value of the available bandwidth in accordance with the packet sizes and a measurement result of the reception intervals of the plurality of measurement packets,
determines whether or not to change the first search range to the second search range, in accordance with the output estimated value and the first determination section, and,
in accordance with a determination result,
sets a change to the second search range, to the search range setting means, and continues searching for the available bandwidth, or
makes an available bandwidth determination of determining the estimated value to be the available bandwidth.

A receiving side device, according to the present invention, comprises:

reception interval measurement means that receives, when a packet train including a plurality of measurement packets having successively increasing packet sizes is generated in accordance with a first search range searched for an available bandwidth, the packet train in which the plurality of measurement packets are transmitted at predetermined transmission intervals, and measures reception intervals of the plurality of measurement packets; and

estimated value calculation means that calculates an estimated value of the available bandwidth in accordance with the packet sizes and a measurement result of the reception intervals of the plurality of measurement packets, and outputs the estimated value.

A storage medium, according to the present invention, stores a transmission side device control program that causes a computer included in a transmission side device to operate as:

search range setting means to which a first search range provided with a first determination section determining whether or not to change the first search range searched for an available bandwidth to a second search range is set;

packet transmission means that generates a packet train including a plurality of measurement packets having successively increasing packet sizes, in accordance with the first search range, and transmits the plurality of measurement packets at predetermined transmission intervals; and

determination means that
receives the packet train,
measures reception intervals of the plurality of measurement packets,
calculates an estimated value of the available bandwidth in accordance with the packet sizes and a measurement result of the reception intervals of the plurality of measurement packets,
determines whether or not to change the first search range to the second search range, in accordance with the output estimated value and the first determination section, and,
in accordance with a determination result,
sets a change to the second search range, to the search range setting means, and continues searching for the available bandwidth, or
makes an available bandwidth determination of determining the estimated value to be the available bandwidth.

A storage medium, according to the present invention, stores a receiving side device control program causing a computer included in a receiving side device to operate as:

reception interval measurement means that receives, when a packet train including a plurality of measurement packets having successively increasing packet sizes is generated in accordance with a first search range searched for an available bandwidth, the packet train in which the plurality of measurement packets are transmitted at predetermined transmission intervals, and measures reception intervals of the plurality of measurement packets; and

estimated value calculation means that calculates an estimated value of the available bandwidth in accordance with the packet sizes and a measurement result of the reception intervals of the plurality of measurement packets, and outputs the estimated value.

### Advantageous Effects of Invention

The present invention is able to improve determination precision of an available bandwidth by properly changing a search range of the available bandwidth.

### BRIEF DESCRIPTION OF DRAWINGS

FIG. 1 is a block diagram illustrating a configuration example of an available bandwidth measuring system according to a first example embodiment of the present invention.

FIG. 2 is a block diagram illustrating a configuration example of a transmission side device according to the first example embodiment of the present invention.

FIG. 3 is a block diagram illustrating a configuration example of a receiving side device according to the first example embodiment of the present invention.

FIG. 4 is a diagram exemplifying a transmitted packet train according to the first example embodiment of the present invention.

FIG. 5 is a diagram exemplifying a received packet train according to the first example embodiment of the present invention.

FIG. 6 is a flowchart illustrating an operation example of the available bandwidth measuring system according to the first example embodiment of the present invention.

FIG. 7 is a diagram illustrating an operation example of the available bandwidth measuring system according to the first example embodiment of the present invention.

FIG. 8 is a flowchart illustrating another operation example of the available bandwidth measuring system according to the first example embodiment of the present invention.

FIG. 9 is a diagram illustrating another operation example of the available bandwidth measuring system according to the first example embodiment of the present invention.

FIG. 10 is a block diagram illustrating a configuration example of an available bandwidth measuring system according to a second example embodiment of the present invention.

FIG. 11 is a flowchart illustrating an operation example of the available bandwidth measuring system according to the second example embodiment of the present invention.

FIG. 12 is a flowchart illustrating an operation example of the available bandwidth measuring system according to the second example embodiment of the present invention.

FIG. 13 is a diagram illustrating an operation example of the available bandwidth measuring system according to the second example embodiment of the present invention.

FIG. 14 is a diagram illustrating an operation example of the available bandwidth measuring system according to the second example embodiment of the present invention.

FIG. 15 is a flowchart illustrating another operation example of the available bandwidth measuring system according to the second example embodiment of the present invention.

FIG. 16 is a flowchart illustrating another operation example of the available bandwidth measuring system according to the second example embodiment of the present invention.

FIG. 17 is a diagram illustrating another operation example of the available bandwidth measuring system according to the second example embodiment of the present invention.

FIG. 18 is a diagram illustrating another operation example of the available bandwidth measuring system according to the second example embodiment of the present invention.

FIG. 19 is a block diagram illustrating a configuration example of an available bandwidth measuring system according to a third example embodiment of the present invention.

FIG. 20 is a flowchart illustrating an operation example of the available bandwidth measuring system according to the third example embodiment of the present invention.

### DESCRIPTION OF EMBODIMENTS

Referring to the drawings, example embodiments of the present invention will be described below in detail.

### First Example Embodiment

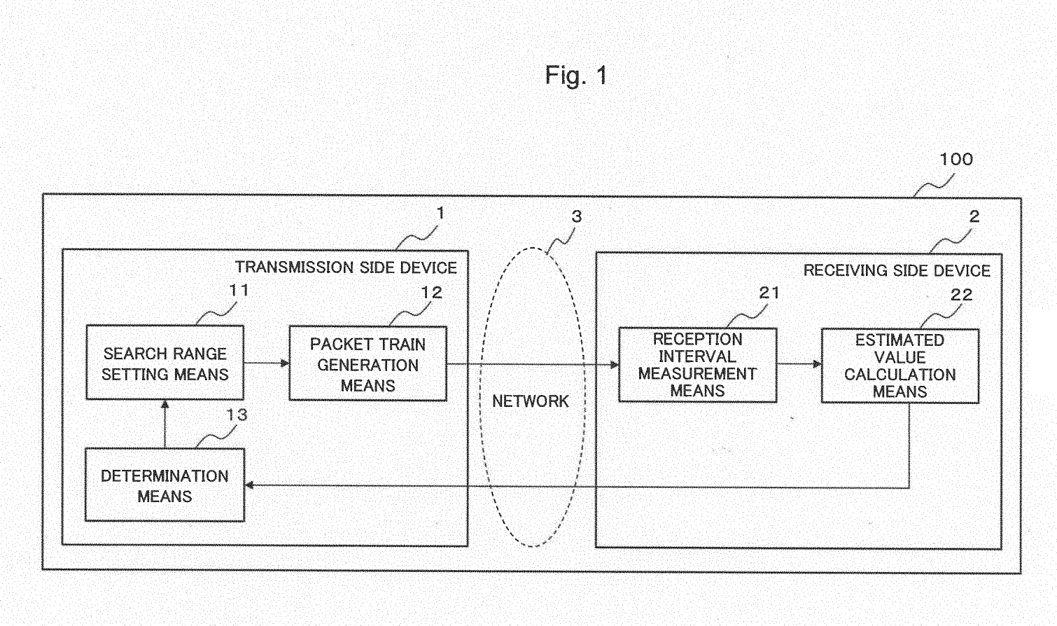

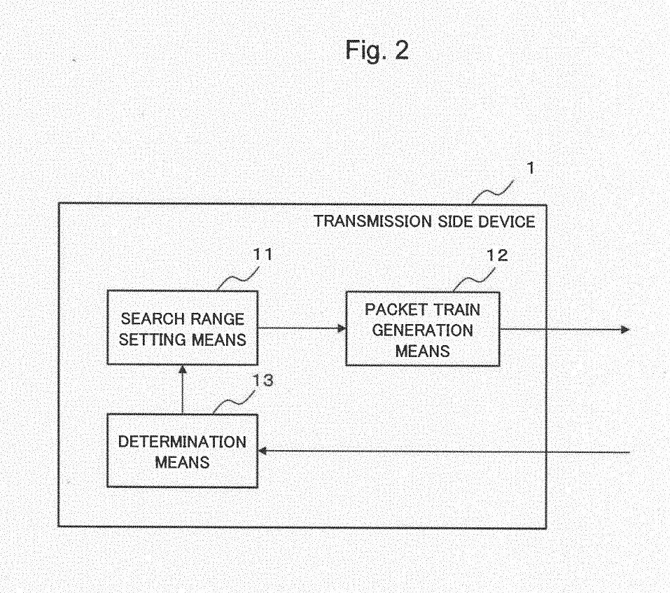

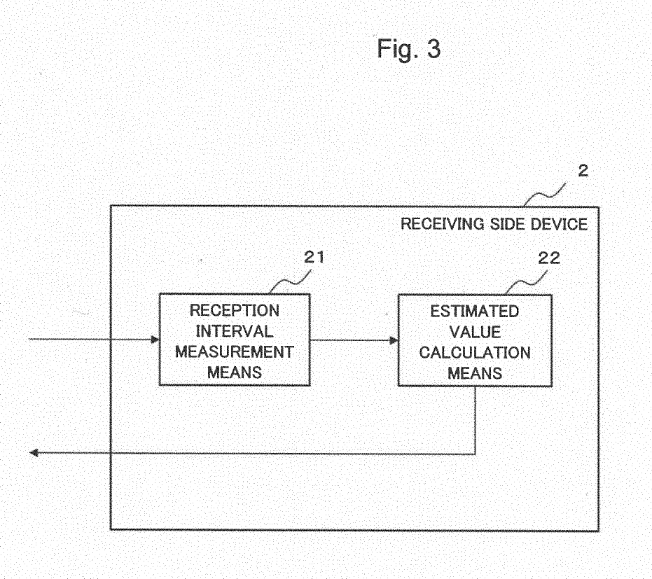

A first example embodiment of the present invention will be described. FIG. 1 is a block diagram illustrating a configuration example of an available bandwidth measuring system 100 according to the present example embodiment. FIG. 2 is a block diagram illustrating a configuration example of a transmission side device 1 in the available bandwidth measuring system 100. FIG. 3 is a block diagram illustrating a configuration example of a receiving side device 2 in the available bandwidth measuring system 100.

Referring to FIGS. 1 to 3, a configuration of the available bandwidth measuring system 100 according to the present example embodiment will be described. The available bandwidth measuring system 100 includes the transmission side device 1 and the receiving side device 2. The transmission side device 1 and the receiving side device 2 communicate through a network 3. The network 3 may be connected to unillustrated devices other than the transmission side device 1 and the receiving side device 2, and cross traffic may flow between the devices.

The transmission side device 1 includes a search range setting means 11, a packet train generation means 12, and a determination means 13. A search range for measuring an available bandwidth from the transmission side device 1 to the receiving side device 2 is set to the search range setting means 11 by the determination means 13. The packet train generation means 12 generates a packet train including a plurality of measurement packets, in accordance with the search range set to the search range setting means 11, and outputs the respective measurement packets at predetermined transmission intervals. The measurement packet and the packet train will be described later.

The determination means 13 determines an available bandwidth and a search range in accordance with measurement information, to be described later, transmitted from the receiving side device 2. The determination means 13 sets a search range to the search range setting means 11 in accordance with the determination result. The determination of an available bandwidth and a search range will be described later.

The receiving side device 2 includes a reception interval measurement means 21 and an estimated value calculation means 22. The reception interval measurement means 21 receives each measurement packet in a packet train output from the transmission side device 1, and measures a reception interval of each measurement packet. The estimated value calculation means 22 calculates an estimated value of an available bandwidth from a packet size and a reception interval of each received measurement packet. The estimated value calculation means 22 outputs measurement information including the calculated estimated value of the available bandwidth. The calculation method of an estimated value of an available bandwidth will be described later. The measurement information may include a packet number of each measurement packet and information indicating a measured reception interval.

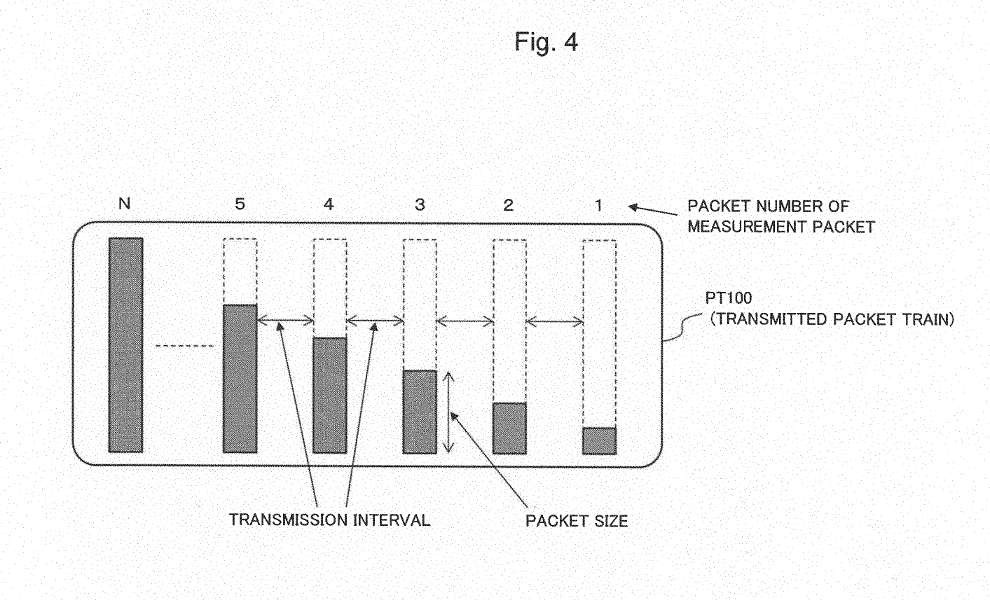

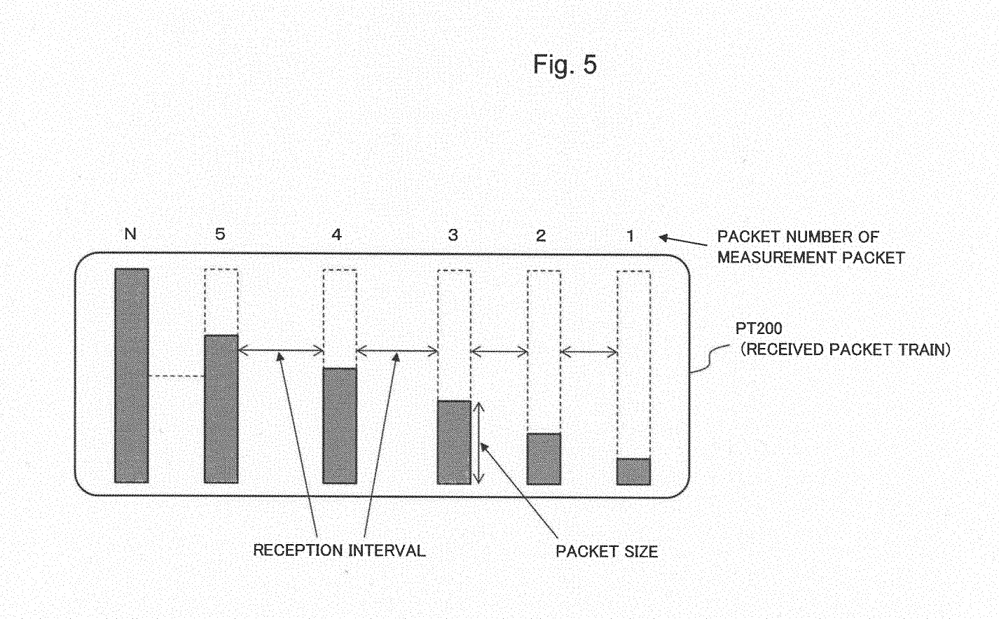

FIG. 4 is a diagram exemplifying a transmitted packet train PT100 according to the present example embodiment. FIG. 5 is a diagram exemplifying a received packet train PT200 according to the present example embodiment. Referring to FIGS. 4 and 5, a measurement packet and a packet train will be described.

The transmitted packet train PT100 is a packet train including a plurality of measurement packets, being generated and output by the packet train generation means 12 in the transmission side device 1. A number of measurement packets is denoted as N (e.g. N is an integer greater than or equal to 3). A packet number is a number distinguishing measurement packets. The transmitted packet train PT100 includes measurement packets arranged in time series from a packet number one to N. For example, an Internet Protocol (IP) packet, a User Datagram Protocol (UDP) packet, a Real-time Transport Protocol (RTP) packet, or the like is used as a measurement packet.

The transmitted packet train PT100 is generated in accordance with a search range set to the search range setting means 11, with a packet number, a packet size, and a transmission interval as parameters.

For example, it is assumed that a transmission interval of each measurement packet is fixed at 1 ms. When a packet size of a first measurement packet is 10 bits, a transmission rate of the first measurement packet is obtained by the following equation. Transmission rate=packet size/transmission interval. Specifically, the transmission rate of the first measurement packet is 10 bits/1 ms=10000 bps or 10 kbps. Similarly, when a packet size of an N-th measurement packet is 1000 bits, a transmission rate of the N-th measurement packet becomes 1000000 bps or 1 Mbps. Each of the first to N-th measurement packets may be generated by successively increasing a packet size from 10 bits to 1000 bits.

Bandwidths of transmission rates of the transmitted packet train PT100 at this time are 10 kbps to 1 Mbps. In other words, the search range setting means 11 sets 10 kbps to 1 Mbps as a search range of an available bandwidth. Then, the packet train generation means 12 generates the transmitted packet train PT100 in accordance with the setting described above and outputs the transmitted packet train PT100.

The received packet train PT200 is a packet train including each measurement packet when the transmitted packet train PT100 is received at the receiving side device 2 through the network 3.

The reception interval measurement means 21 measures a reception interval of each measurement packet included in the received packet train PT200 received through the network 3. The estimated value calculation means 22 calculates an estimated value of an available bandwidth, in accordance with a packet size and a reception interval of each measurement packet.

For example, it is assumed that every reception interval of a measurement packet measured by the reception interval measurement means 21 is 1 ms. At this time, when a packet size of a first measurement packet is 10 bits, a reception rate of the first measurement packet is obtained by the following equation. Reception rate=packet size/reception interval. Specifically, the reception rate of the first measurement packet is 10 bits/1 ms=10000 bps or 10 kbps. Similarly, when a packet size of an N-th measurement packet is 1000 bits, a reception rate of the N-th measurement packet is 1000000 bps or 1 Mbps. In this case, the transmission interval and the reception interval of each measurement packet in the transmitted packet train PT100 are equivalent, and therefore each packet is received by the receiving side device 2 through the network 3 without delay. Accordingly, the estimated value calculation means 22 determines an estimated value of the available bandwidth to be 1 Mbps being the upper limit of the search range.

At this time, influence of cross traffic disturbing transmission of each measurement packet is not identified in a range from 10 kbps to 1 Mbps being the search range. Accordingly, the determination means 13 determines to set a search range changed to a range higher than the range from 10 kbps to 1 Mbps to the search range setting means 11, in accordance with the estimated value of the available bandwidth by the estimated value calculation means 22. Further, when 1 Mbps being the estimated reception rate matches a physical bandwidth of the network 3, the determination means 13 determines the available bandwidth to be 1 Mbps.

Meanwhile, it is assumed that each of the reception intervals of the first and succeeding measurement packets measured by the reception interval measurement means 21 exceeds 1 ms. At this time, every one of the reception intervals of the first and succeeding measurement packets exceeds the transmission interval. In this case, the reception interval of each measurement packet in the transmitted packet train PT100 is greater than the transmission interval thereof, and therefore each measurement packet is received by the receiving side device 2 with transmission delay due to influence of cross traffic in the network 3. Accordingly, the estimated value calculation means 22 determines an estimated value of the available bandwidth to be 10 kbps being the lower limit of the search range.

Transmission of every measurement packet is disturbed in the range from 10 kbps to 1 Mbps being the search range at this time. Accordingly, the determination means 13 determines to set a search range changed to a range lower than the range from 10 kbps to 1 Mbps to the search range setting means 11, in accordance with the estimated value of the available bandwidth by the estimated value calculation means 22.

Further, it is assumed that each of reception intervals of an M-th (M is an integer greater than or equal to 2 and less than or equal to N) and succeeding measurement packets measured by the reception interval measurement means 21 exceeds 1 ms. At this time, when a packet size of an (M−1)-th measurement packet is 500 bits, a reception rate of the (M−1)-th measurement packet is 500 bits/1 ms=500000 bps or 500 kbps. In this case, each of measurement packets up to the (M−1)-th measurement packet in the transmitted packet train PT100 is received by the receiving side device 2 through the network 3 without delay. The M-th and succeeding measurement packets are received by the receiving side device 2 with transmission delay due to influence of cross traffic in the network 3. In other words, influence of cross traffic disturbing transmission of each measurement packet is not identified in a range from 10 kbps to 500 kbps. Accordingly, the estimated value calculation means 22 calculates an estimated value of the available bandwidth by using a measurement packet with a maximum packet size out of measurement packets reception intervals of which being equal to transmission intervals. Specifically, the estimated value calculation means 22 determines the estimated value of the available bandwidth to be 500 kbps being the reception rate of the (M−1)-th measurement packet. The determination means 13 determines the available bandwidth to be 500 kbps in the search range from 10 kbps to 1 Mbps, in accordance with the estimated value of the available bandwidth by the estimated value calculation means 22.

Note that a specific generation method of the aforementioned measurement packet and packet train, and a calculation method of an estimated value of an available bandwidth are practiced in accordance with, for example, the technology described in PTL 1.

Thus, the transmission side device 1 in the available bandwidth measuring system 100 creates each measurement packet in accordance with a search range setting, and outputs the packets as a packet train. The receiving side device 2 in the available bandwidth measuring system 100 calculates a reception rate and an estimated value of an available bandwidth by measuring a reception interval of each measurement packet. In the available bandwidth measuring system 100, the receiving side device 2 outputs the calculated estimated value of the available bandwidth, and the transmission side device 1 is able to determine the available bandwidth and change of a search range, in accordance with the estimated value of the available bandwidth. When the estimated value of the available bandwidth is the upper limit or the lower limit of the search range, the determination means 13 determines that a true value of the available bandwidth exists outside the search range, and determines change of the search range. Specifically, when the estimated value of the available bandwidth is the upper limit of the search range, the determination means 13 changes the search range to the higher side. Further, when the estimated value of the available bandwidth is the lower limit of the search range, the determination means 13 changes the search range to the lower side. Note that the aforementioned change of the search range may be made when the estimated value of the available bandwidth is within a predetermined range from the upper limit or the lower limit of the search range.

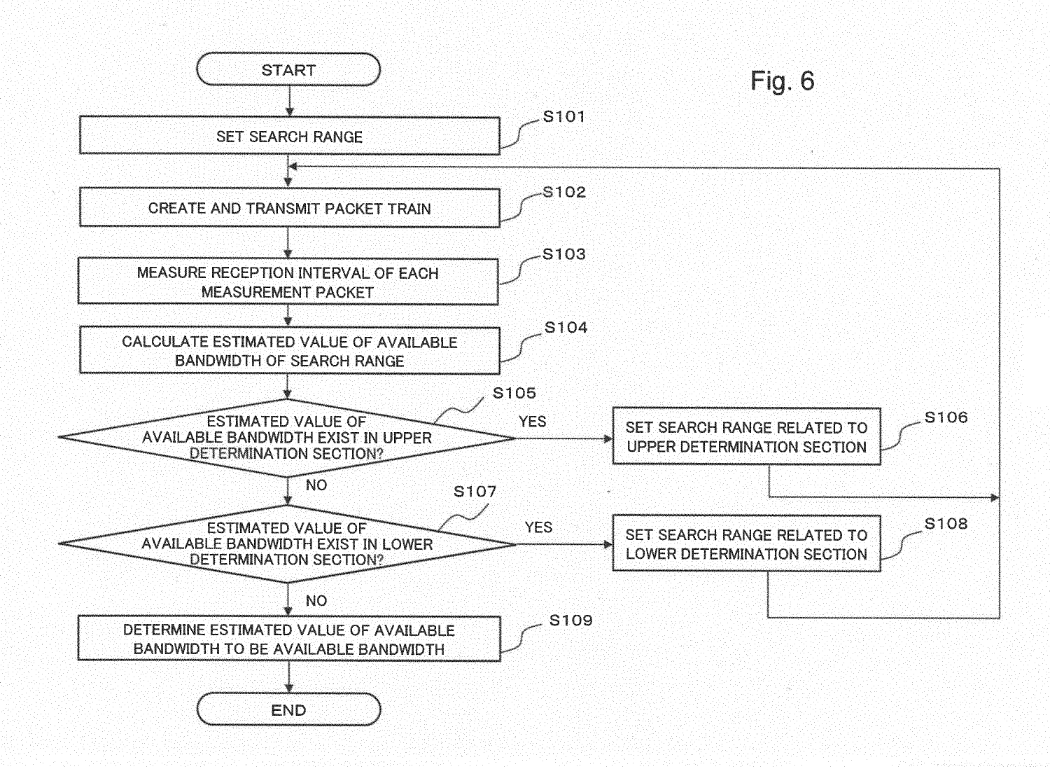

FIG. 6 is a flowchart illustrating an operation example of the available bandwidth measuring system 100 according to the present example embodiment. Referring to FIG. 6, an operation of the available bandwidth measuring system 100 will be described.

The determination means 13 sets a search range to the search range setting means 11 (S101). The packet train generation means 12 creates a packet train in accordance with the search range set by the search range setting means 11 and outputs the packet train (S102). As illustrated in FIG. 4, the packet train includes a plurality of measurement packets in accordance with the search range set by the search range setting means 11, and the respective measurement packets are output at predetermined transmission intervals.

The reception interval measurement means 21 receives each measurement packet in the packet train output from the packet train generation means 12 and measures a reception interval of each received measurement packet (S103). The estimated value calculation means 22 calculates an estimated value of an available bandwidth from a packet size and a reception interval of each received measurement packet, and outputs the calculated estimated value of the available bandwidth (S104).

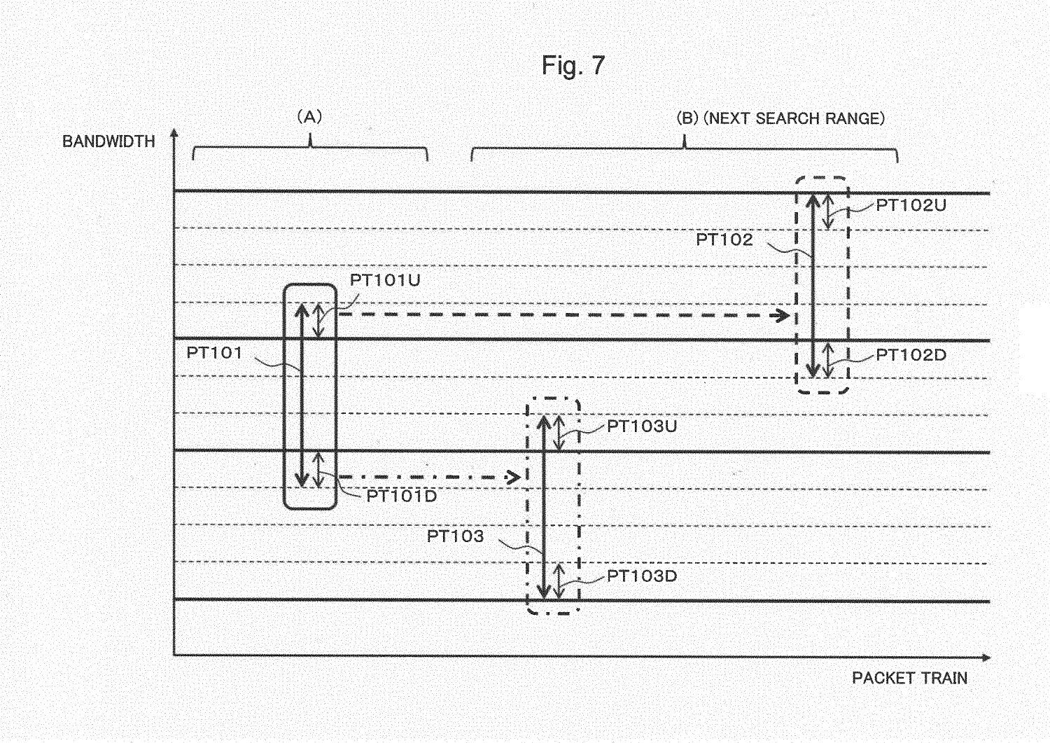

FIG. 7 is a diagram illustrating an operation example of the available bandwidth measuring system 100 according to the present example embodiment. A range (A) in FIG. 7 illustrates a packet train PT101 including a plurality of measurement packets. A range (B) in FIG. 7 illustrates packet trains PT102 and PT103 as next search ranges to be shifted from PT101. PT102 is a search range shifted to the higher side from a search range related to PT101, and is referred to as an upper search range. PT103 is a search range shifted to the lower side from the search range related to PT101, and is referred to as a lower search range. In other words, PT102 and PT103 are packet trains related to search ranges being adjacent to PT101 on the higher side and the lower side of the search range of PT101, respectively.

PT101 is related to a search range which is set to the search range setting means 11. PT101U is an upper determination section in PT101. When an estimated value of an available bandwidth exists in the section, there is a possibility that the available bandwidth also exists in a higher region. Accordingly, the determination means 13 determines that PT102 being a search range higher than PT101 should be set as a next search range. Note that the upper determination section PT101U is set in a bandwidth being the top tenth of the search range, for example. PT101D is a lower determination section in PT101. When an estimated value of the available bandwidth exists in the section, there is a possibility that the available bandwidth also exists in a lower region. Accordingly, the determination means 13 determines that PT103 being a search range lower than PT101 should be set as a next search range. Note that the lower determination section PT101D is set in a bandwidth being the bottom tenth of the search range, for example.

Referring to FIGS. 6 and 7, a determination operation of an available bandwidth and search range change, being performed by the determination means 13 in accordance with an estimated value of the available bandwidth by the estimated value calculation means 22, will be described.

The determination means 13 determines whether or not an estimated value of an available bandwidth related to PT101 exists in a preset upper determination section PT101U (S105). When the estimated value of the available bandwidth exists in the upper determination section PT101U (S105: Yes), the determination means 13 sets PT102 as a next search range to the search range setting means 11 and returns to the processing in Step S102 (S106).

When the estimated value of the available bandwidth does not exist in the upper determination section PT101U (S105: No), the determination means 13 determines whether or not the estimated value of the available bandwidth exists in a lower determination section PT101D (S107). When the estimated value of the available bandwidth exists in the lower determination section PT101D (S107: Yes), the determination means 13 sets PT103 as a next search range to the search range setting means 11 and returns to the processing in Step S102 (S108).

When the estimated value of the available bandwidth does not exist in the lower determination section PT101D (S107: No), the determination means 13 performs processing in next Step S109. Specifically, the determination means 13 determines the estimated value of the available bandwidth of the packet train PT101 to be the available bandwidth (S109).

Note that the determination means 13 may transit to the processing in Step S106 when the estimated value of the available bandwidth takes a value greater than a value related to a range of the upper determination section PT101U, and may transit to the processing in Step S108 when the estimated value of the available bandwidth takes a value less than a value related to a range of the lower determination section PT101D. Further, the determination means 13 may be configured to set a search range related to the estimated value and transit to the processing in Step S102, when the estimated value of the available bandwidth takes a value greater than a value related to the range of the upper determination section PT101U or a value less than a value related to the range of the lower determination section PT101D.

Thus, the available bandwidth measuring system 100 is able to output a packet train PT101 from the transmission side device 1 and determine an available bandwidth in accordance with an estimated value of the available bandwidth from the receiving side device 2. Additionally, the transmission side device 1 is able to shift the search range to a higher or lower search range in accordance with the estimated value of the available bandwidth, and continue the search for the available bandwidth.

Note that the search ranges of the packet train PT102 and the search range of PT103 are provided in a manner partially and mutually overlapping with PT101, with respect to the search range of the packet train PT101. That is to say, by PT101 and PT102, and PT101 and PT103 being provided with partially and mutually overlapping ranges, influence of noise and fluctuation of cross traffic on a reception interval of each measurement packet in PT101 can be reduced. Even when a reception interval of each measurement packet in PT101 is influenced by noise and fluctuation in the network 3, a reception interval is measured again in a range overlapping with PT102 or PT103. Accordingly, a search for the available bandwidth is performed again in the overlapping range, and therefore influence of noise and fluctuation is reduced.

Further, the upper determination section PT101U for determining a search range shift from PT101 to PT102, and a lower determination section PT102D for determining a search range shift from PT102 to PT101 do not overlap one another. The reason is that, when the determination sections PT101U and the PT102D overlap one another, a determination of a shift from PT101 to PT102 and a determination of a shift from PT102 to PT101 may be alternately repeated in the overlapping range. In order to prevent such alternate determinations, the determination sections PT101U and PT102D do not overlap one another. Similarly, determination sections PT101D and PT103U do not overlap one another.

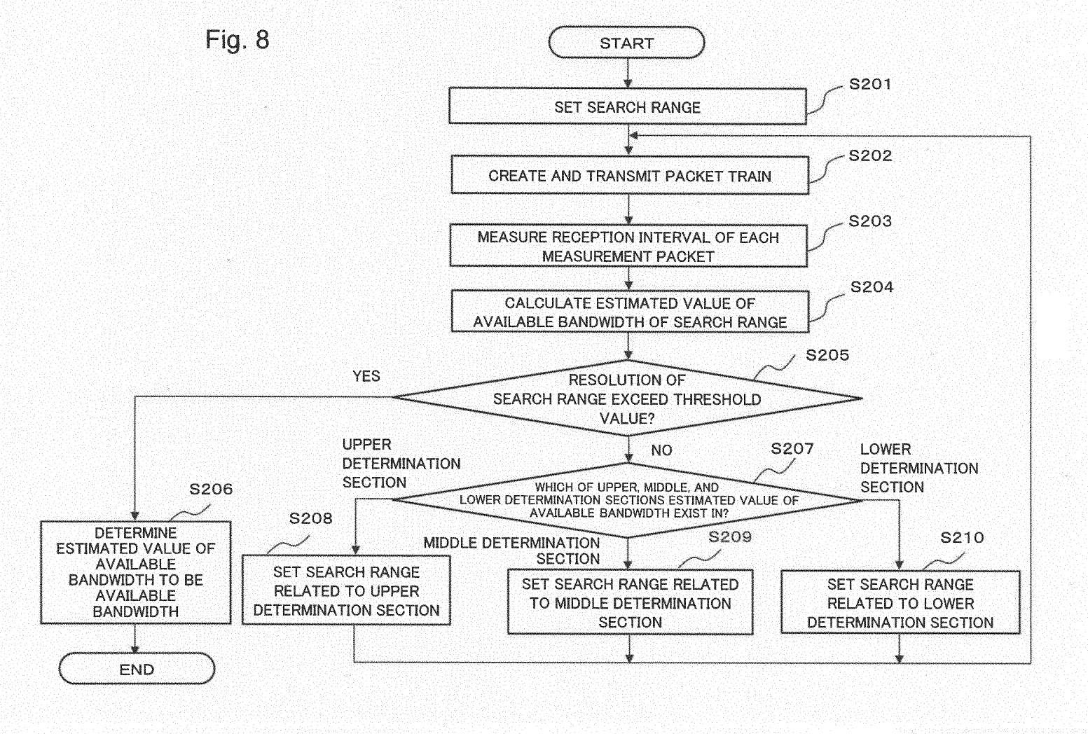

FIG. 8 is a flowchart illustrating another operation example of the available bandwidth measuring system 100 according to the present example embodiment. The operation method described by referring to FIGS. 6 and 7 is a method of first searching a partial bandwidth (a bandwidth illustrated in the middle in FIG. 7) of an entire bandwidth of the network 3, and, when an estimated value of an available bandwidth exists in an upper determination section or a lower determination section, shifting the search range higher or lower to search again. Note that the method is referred to as a shift method. A method described below is a method of first searching the entire bandwidth of the network 3 at low resolution, subsequently dividing the entire bandwidth into several parts, specifying a divided bandwidth in which an estimated value of an available bandwidth searched at low resolution exists, and searching the specified bandwidth at higher resolution. The method is referred to as a division method.

Referring to FIG. 8, another operation of the available bandwidth measuring system 100 will be described.

The determination means 13 sets a search range to the search range setting means 11 (S201). The packet train generation means 12 creates a packet train in accordance with the search range set to the search range setting means 11 and outputs the packet train (S202).

The reception interval measurement means 21 receives each measurement packet in the packet train output from the packet train generation means 12 and measures a reception interval of each measurement packet (S203). The estimated value calculation means 22 calculates an estimated value of an available bandwidth from a packet size and a reception interval of each received measurement packet, and outputs the calculated estimated value of the available bandwidth (S204).

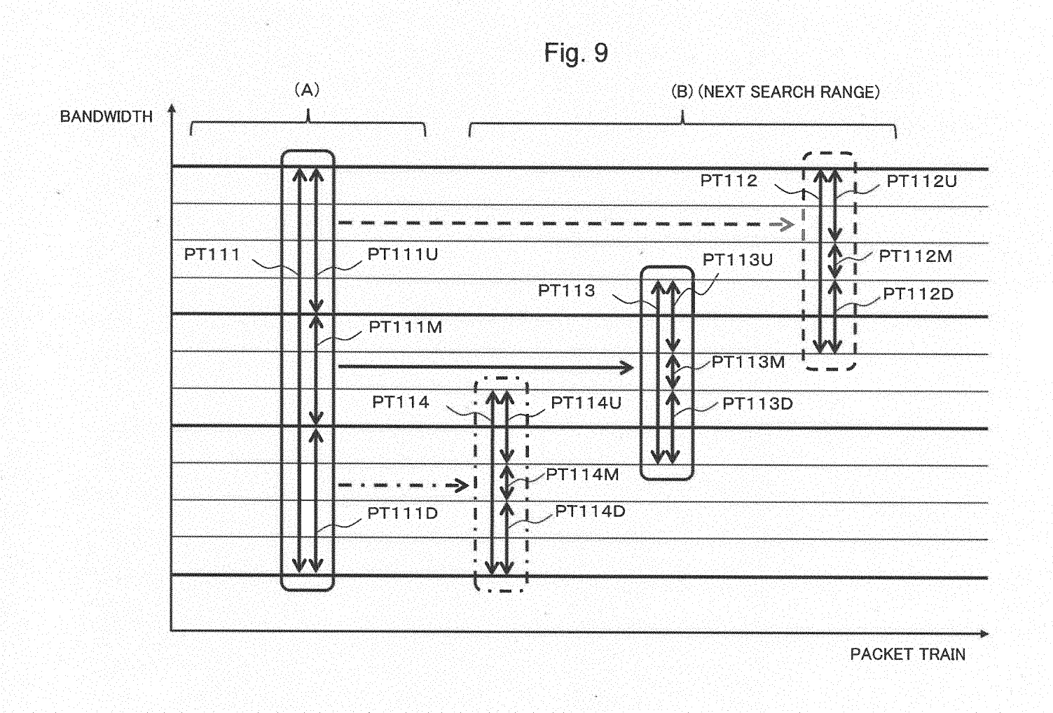

FIG. 9 is a diagram illustrating another operation example of the available bandwidth measuring system 100 according to the present example embodiment. A range (A) in FIG. 9 illustrates a packet train PT111 including a plurality of measurement packets. A range (B) in FIG. 9 illustrates packet trains PT112, PT113, and PT114 when dividing the packet train PT111 into next search ranges. An upper limit and a lower limit of a search range related to PT111 are an upper limit and a lower limit of a physical bandwidth of the network 3. PT112 is related to an upper search range being a higher division of the search range related to PT111. PT113 is related to a middle search range being a middle division of the search range related to PT111. PT114 is related to a lower side search range being a lower division of the search range related to PT111. In other words, PT112, PT113, and PT114 are packet trains respectively related to search ranges obtained by dividing the search range of PT111 into three.

PT111 is related to a search range set to the search range setting means 11. PT111U is an upper determination section, and, when an estimated value of an available bandwidth exists in the section, the determination means 13 determines PT112 to be a next search range. PT111M is a middle determination section, and, when the estimated value of the available bandwidth exists in the section, the determination means 13 determines PT113 to be a next search range. PT111D is a lower determination section, and, when the estimated value of the available bandwidth exists in the section, the determination means 13 determines PT114 to be a next search range. Note that the search range related to PT111 may be equally divided into three as upper, middle, and lower search ranges, or may be divided into three at a predetermined ratio. Further, while a number of divisions is assumed to be three in the description, the number of divisions may be a number greater than or equal to two.

Referring to FIGS. 8 and 9, a determination operation of an available bandwidth and search range change, being performed by the determination means 13 in accordance with an estimated value of the available bandwidth by the estimated value calculation means 22, will be described.

The determination means 13 determines whether or not resolution of a search range searched by PT111 exceeds a predetermined threshold value, in accordance with a number of measurement packets related to PT111 (S205).

The resolution of a search range is given by, for example, a number of measurement packets created for obtaining an available bandwidth with respect to the search range. Specifically, resolution of a search range is higher in a case that twenty measurement packets are created with respect to a search range of 100 Mbps than in a case that five measurement packets are created. At this time, assuming resolution of a search range is given by search range/number of measurement packets, the resolution in the former case is 20 Mbps, and the resolution in the latter case is 5 Mbps. That is to say, the latter resolution is higher and enables determination of an available bandwidth in the search range with higher precision.

When the resolution of the searched search range exceeds the predetermined threshold value (S205: Yes), the determination means 13 performs processing in next Step S206. Specifically, the determination means 13 determines the estimated value of the available bandwidth of PT111 to be the available bandwidth (S206). In this case, the determination means 13 determines the available bandwidth with a determination that the available bandwidth can be measured with a plurality of measurement packets related to the search range of PT111 at predetermined resolution, that is, with predetermined precision.

By contrast, when the resolution of the searched search range does not exceed the predetermined threshold value (S205: No), the determination means 13 determines in which preset determination section the estimated value of the available bandwidth related to PT111 exists (S207). In this case, the determination means 13 determines that the predetermined resolution, that is, the predetermined precision cannot be obtained with a plurality of measurement packets related to the search range of PT111, and continues to search a divided search range described below.

When the estimated value of the available bandwidth exists in the upper determination section PT111U (S207: upper determination section), the determination means 13 sets PT112 to the search range setting means 11 as a next search range, and returns to the processing in Step S202 (S208).

When the estimated value of the available bandwidth exists in the middle determination section PT111M (S207: middle determination section), the determination means 13 sets PT113 to the search range setting means 11 as a next search range, and returns to the processing in Step S202 (S209).

When the estimated value of the available bandwidth exists in the lower determination section PT111D (S207: lower determination section), the determination means 13 sets PT114 to the search range setting means 11 as a next search range, and returns to the processing in Step S202 (S210).

Thus, the available bandwidth measuring system 100 is able to output a packet train PT111 from the transmission side device 1 and determine an available bandwidth in accordance with an estimated value of the available bandwidth by the receiving side device 2. Additionally, the transmission side device 1 is able to successively divide a search range into upper, middle and lower search ranges in accordance with the estimated value to continue the search for the available bandwidth. By successively dividing the search range, the search range is narrowed and resolution in the search range is increased. The transmission side device 1 determines the available bandwidth in accordance with an estimated value of the available bandwidth related to a search range securing predetermined resolution, that is, predetermined precision, and therefore is able to improve precision of the available bandwidth.

Note that search ranges of PT112, PT113, and PT114, being divisions of the search range of the packet train PT111 are provided in a partially and mutually overlapping manner. Specifically, by part of PT112 and part of PT113, and part of PT113 and part of PT114 provided with overlapping search ranges, influence of noise and fluctuation of cross traffic on a reception interval of each measurement packet in PT111 can be reduced. Even when a reception interval of each measurement packet in PT111 is influenced by noise and fluctuation in the network 3, a reception interval is measured again in a range in which part of PT112 and part of PT113, or part of PT113 and part of PT114 overlap one another. Consequently, the search for the available bandwidth is performed again in the overlapping range, and therefore influence of noise and fluctuation is reduced.

Further, the search range does not return to the search range before division after determination to search for the available bandwidth in the search range of PT112, PT113, or PT114 provided by division of the search range of PT111. Accordingly, the aforementioned alternate determination does not occur, and therefore each determination section in the search range before the division may overlap with each determination section in the related search range after the division. In other words, each determination section in the search range before the division may be included in each determination section obtained by further dividing each related search range after the division.

As described above, the transmission side device in the available bandwidth measuring system 100 according to the present example embodiment transmits a packet train including a plurality of measurement pallets for measuring an available bandwidth, in accordance with a set search range. The receiving side device measures a reception interval of each measurement packet in the received packet train, and outputs an estimated value of the available bandwidth in accordance with a packet size and a reception interval of each measurement packet. The transmission side device is able to properly change a search range by determining an estimated value of the available bandwidth in accordance with a preset determination section, setting a next search range, and shifting or dividing the search range. The transmission side device searches for the available bandwidth by changing a search range, and therefore is able to determine the available bandwidth with improved precision.

As described above, the available bandwidth measuring system according to the present example embodiment is able to improve precision of an available bandwidth by properly changing a search range of the available bandwidth.

Note that a search for an available bandwidth, according to the present example embodiment, has been described to be performed by shifting or dividing a search range. However, the search for an available bandwidth is not limited to either method of shifting or dividing a search range. For example, the search for an available bandwidth may be performed by combining the method of shifting a search range with the method of dividing a search range. Specifically, a search may start from successively dividing a wideband search range with a bottleneck being a physical bandwidth of a network being a search target of an available bandwidth as an upper limit, and the available bandwidth may be determined in a search range at preset resolution. Subsequently, a search may start in a search range shifted from the search range including the determined available bandwidth, and the available bandwidth may be determined in the shifted search range.

Further, a transmission interval of each measurement packet, according to the present example embodiment, has been described to be 1 ms. However, the transmission interval of each measurement packet is not limited to 1 ms. That is to say, the transmission interval of each measurement packet may be related to a bandwidth of a search range related to the packet train.

Further, a packet size of each measurement packet, according to the present example embodiment, has been described to be 10 to 1000 bits. However, the packet size of each measurement packet is not limited to 10 to 1000 bits. That is to say, the packet size of each measurement packet may be related to a bandwidth of a search range related to the packet train.

Note that in the shift method of a search range, according to the present example embodiment, each of upper and lower determination sections has been described to have a bandwidth of one tenth of a search range. However, the numerical value indicated as the bandwidth of each of the upper and lower determination sections exemplifies the upper and lower determination sections according to the present invention, and the bandwidth of each determination section is not limited to the indicated numerical value.

Further, a number of a packet train for obtaining an available bandwidth in each search range, according to the present example embodiment, has been described to be one. However, a number of packet trains in each search range may be two or more. For example, a plurality of packet trains may be transmitted in a same search range. In this case, each estimated value of an available bandwidth calculated from each packet train is collected. The search range may be changed in accordance with in which determination section a maximum estimated value of the collected estimated values of the available bandwidth exists. Further, the search range may be changed in accordance with in which determination section a mean value, a median value, or a minimum value of the aforementioned collected estimated values of the available bandwidth exists. Similarly, the available bandwidth of the search range may be determined as a maximum value, a mean value, a median value, or a minimum value of the estimated values of the available bandwidth calculated in the respective aforementioned packet trains. In any case, search range change and an available bandwidth determination are performed in accordance with an estimated value of an available bandwidth calculated in a packet train related to the search range.

Further, in the division method of a search range, according to the present example embodiment, an upper limit and a lower limit of a search range before division have been described to be an upper limit and a lower limit of a physical bandwidth of a network being a search target of an available bandwidth. However, the upper limit and the lower limit of the search range before division are not limited to the upper limit and the lower limit of the physical bandwidth of the network. For example, the upper limit may be an upper limit of the physical bandwidth of the network, and the lower limit may be a preset lower limit. Further, the upper limit of the search range before division may be a preset upper limit. In other words, a search range before division may be set in a bandwidth assumed to include a true value of an available bandwidth in a search.

Further, in the division method of a search range, according to the present example embodiment, a search range before division has been described to be divided into three. However, the number of divisions of a search range is not limited to three. Specifically, a search range of an available bandwidth may be divided into search ranges securing predetermined resolution, or division may be repeated until the predetermined resolution is secured, and the number of divisions of the search range has only to be two or more. Further a search range may be equally divided or may be divided at a predetermined ratio.

Further, the flowcharts and diagrams illustrated in FIGS. 6 to 9 are exemplifications as operation examples of the available bandwidth measuring system 100 according to the present invention, and the operation of the available bandwidth measuring system according to the present invention is not limited to the illustrations of the flowcharts and the diagrams.

### Second Example Embodiment

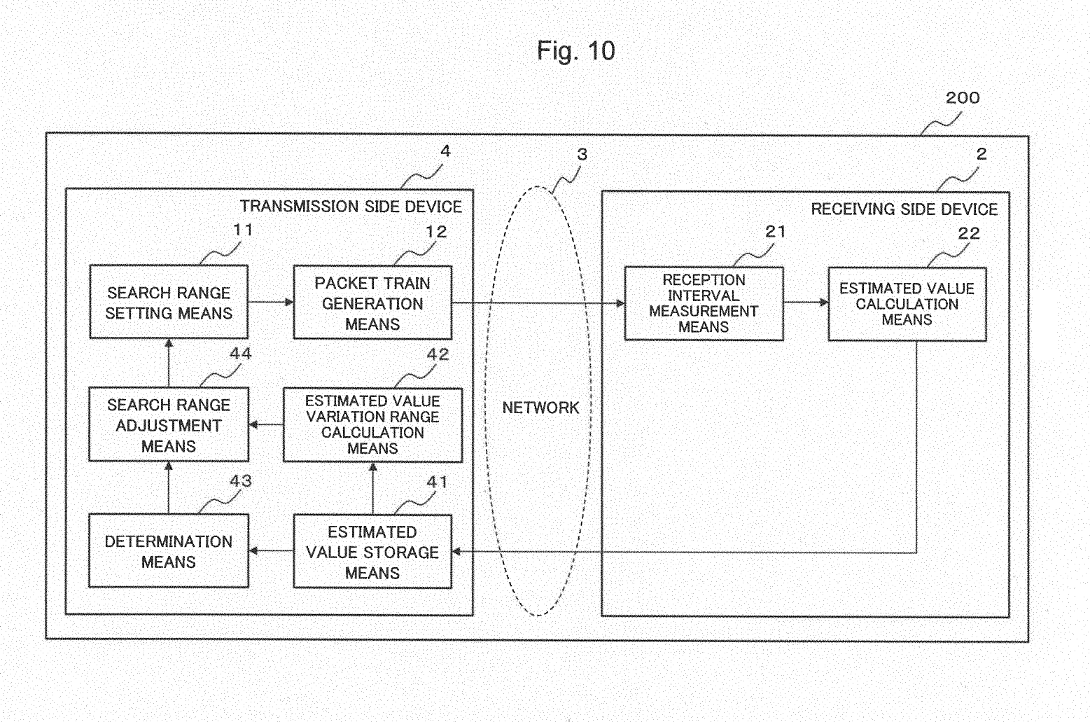

A second example embodiment of the present invention will be described. FIG. 10 is a block diagram illustrating a configuration example of an available bandwidth measuring system 200 according to the second example embodiment of the present invention.

Referring to FIG. 10, a configuration of the available bandwidth measuring system 200 according to the present example embodiment will be described. The transmission side device 1 described by referring to FIG. 1 is changed to a transmission side device 4 in the available bandwidth measuring system 200. The transmission side device 4 differs from the configuration according to the first example embodiment in that an estimated value storage means 41, an estimated value variation range calculation means 42, and a search range adjustment means 44 are added to the transmission side device 1 described by referring to FIG. 1, and the determination means 13 is changed to a determination means 43. A same designation and a same reference number are hereinafter given to a component same as the first example embodiment, description thereof is omitted, and changes will be described.

The transmission side device 4 includes a search range setting means 11, a packet train generation means 12, the estimated value storage means 41, the estimated value variation range calculation means 42, the determination means 43, and the search range adjustment means 44. A search range for measuring an available bandwidth from the transmission side device 4 to the receiving side device 2 is set to the search range setting means 11 by the search range adjustment means 44. The packet train generation means 12 generates a packet train including a plurality of measurement packets, in accordance with the search range set to the search range setting means 11, and outputs the respective measurement packets at predetermined transmission intervals.

The estimated value storage means 41 stores an estimated value of an available bandwidth from the receiving side device 2. The estimated value variation range calculation means 42 calculates a variation range of estimated values of the available bandwidth stored in the estimated value storage means 41. The variation range of estimated values is for grasping a variation state of estimated values of the available bandwidth, the estimated values being calculated by a plurality of packet trains related to a search range. Accordingly, the variation range of estimated values is calculated as, for example, a bandwidth range represented by a maximum estimated value of the available bandwidth and a minimum estimated value of the available bandwidth, with respect to the search range. The determination means 43 determines an available bandwidth and a search range in accordance with an estimated value of an available bandwidth stored in the estimated value storage means 41. In accordance with the determination result, the determination means 43 sets a search range to the search range adjustment means 44. The search range adjustment means 44 adjusts a search range set by the determination means 43, in accordance with an estimated value variation range by the estimated value variation range calculation means 42, and sets the adjusted search range to the search range setting means 11.

The receiving side device 2 includes a reception interval measurement means 21 and an estimated value calculation means 22. The reception interval measurement means 21 receives each measurement packet in a packet train output from the transmission side device 4, and measures a reception interval of each received measurement packet. The estimated value calculation means 22 calculates an estimated value of an available bandwidth from a packet size and a reception interval of each received measurement packet. The estimated value calculation means 22 outputs the calculated estimated value of the available bandwidth.

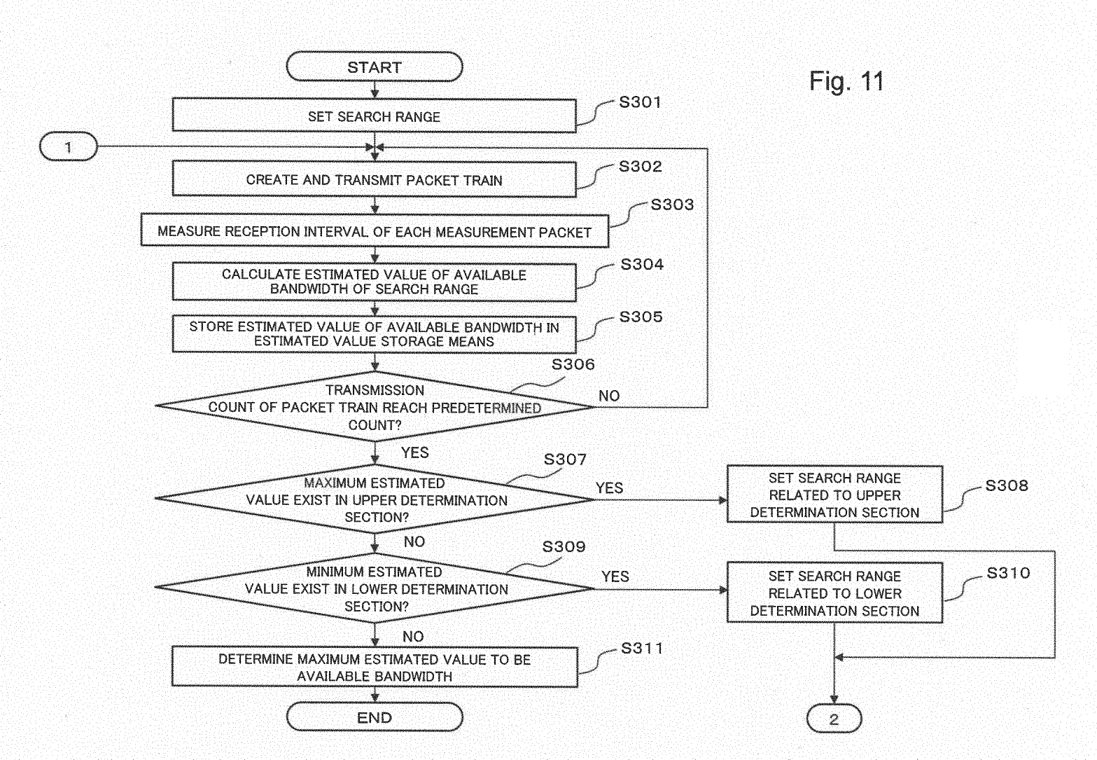

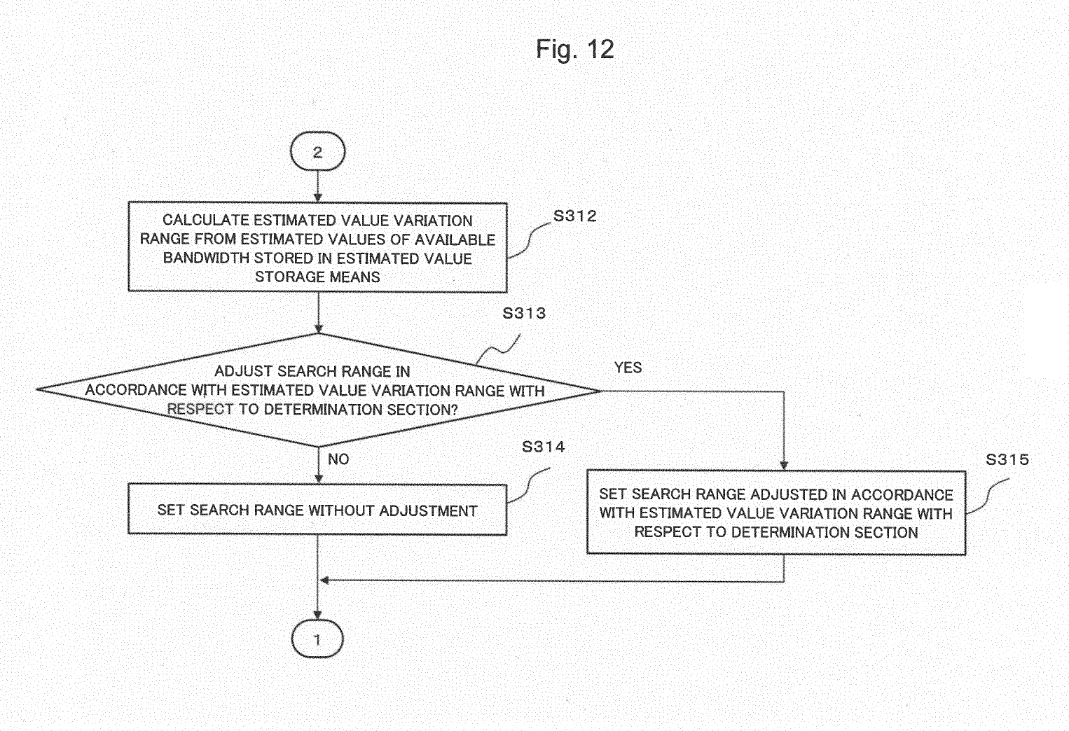

FIGS. 11 and 12 are flowcharts illustrating an operation example of the available bandwidth measuring system 200 according to the present example embodiment. Referring to FIGS. 11 and 12, an operation of the available bandwidth measuring system 200 will be described.

The determination means 43 sets a search range to the search range setting means 11 through the search range adjustment means 44 (S301). The packet train generation means 12 creates a packet train in accordance with the search range set to the search range setting means 11, and outputs the packet train (S302). The packet train includes a plurality of measurement packets in accordance with the search range set to the search range setting means 11, and the respective measurement packets are output at predetermined transmission intervals.

The reception interval measurement means 21 receives each measurement packet in the packet train output from the packet train generation means 12, and measures a reception interval of each received measurement packet (S303). The estimated value calculation means 22 calculates an estimated value of an available bandwidth from a packet size and a reception interval of each received measurement packet, and outputs the calculated estimated value of the available bandwidth (S304).

The estimated value storage means 41 stores the estimated value of the available bandwidth from the estimated value calculation means 22 (S305).

The determination means 43 determines whether or not a transmission count of a packet train PT101 reaches a preset predetermined count (S306). When the transmission count of the packet train PT101 does not reach the predetermined count (S306: No), the determination means 43 returns to the processing in Step S302.

When the transmission count of the packet train PT101 reaches the predetermined count (S306: Yes), the determination means 43 transits to processing in Step S307.

The determination means 43 collects estimated values of the available bandwidth, the estimated values being calculated by the packet trains PT101 transmitted a predetermined number of times and being stored in the estimated value storage means 41. The determination means 43 determines whether or not a maximum estimated value of the collected estimated values of the available bandwidth exists in an upper determination section PT101U (S307). When the aforementioned maximum estimated value exists in the upper determination section PT101U (S307: Yes), the determination means 43 sets PT102 to the search range adjustment means 44 as a next search range, and transits to processing in Step S312 (S308). When the aforementioned maximum estimated value does not exist in the upper determination section PT101U (S307: No), the determination means 43 transits to processing in Step S309.

The determination means 43 determines whether or not a minimum estimated value of the aforementioned collected estimated values of the available bandwidth exists in a lower determination section PT101D (S309). When the aforementioned minimum estimated value exists in the lower determination section PT101D (S309: Yes), the determination means 43 sets PT103 to the search range adjustment means 44 as a next search range, and transits to processing in Step S312 (S310). When the aforementioned minimum estimated value does not exist in the lower determination section PT101U (S309: No), the determination means 43 transits to processing in Step S311.

Note that the determination means 43 may transit to the processing in Step S308 when an estimated value of the available bandwidth takes a value greater than a value related to a range of the upper determination section PT101U, and may transit to the processing in Step S310 when an estimated value of the available bandwidth takes a value less than a value related to a range of the lower determination section PT101D. Further, the determination means 43 may be configured to set a search range related to an estimated value of the available bandwidth and transit to the processing in Step S312, when the estimated value takes a value greater than a value related to the range of the upper determination section PT101U or the estimated value takes a value less than a value related to the range of the lower determination section PT101D.

The determination means 43 determines, for example, a maximum estimated value of the estimated values of the available bandwidth calculated by the respective aforementioned packet trains PT101 to be the available bandwidth (S311). Additionally, the determination means 43 may determine a mean value, a median value, or a minimum value of the aforementioned estimated values of the available bandwidth to be the available bandwidth of the search range.

Thus, the determination means 43 determines an available bandwidth and search range change, in accordance with estimated values of an available bandwidth stored in the estimated value storage means 41. The determination of an available bandwidth and search range change made by the determination means 43 is similar to the description referring to FIGS. 6 and 7 except that the determination is made in accordance with estimated values of the available bandwidth stored in the estimated value storage means 41.

When a search range being a target of change is determined, the estimated value variation range calculation means 42 calculates a bandwidth range represented by a maximum estimated value and a minimum estimated value of the aforementioned estimated values of the available bandwidth, as an estimated value variation range (S312). The search range adjustment means 44 determines whether or not to adjust the search range set by the determination means 43, in accordance with the estimated value variation range with respect to the determination section (S313).

Thus, the available bandwidth measuring system 200 according to the present example embodiment is able to determine an available bandwidth and search range change, in accordance with estimated values of the available bandwidth calculated by using a plurality of packet trains.

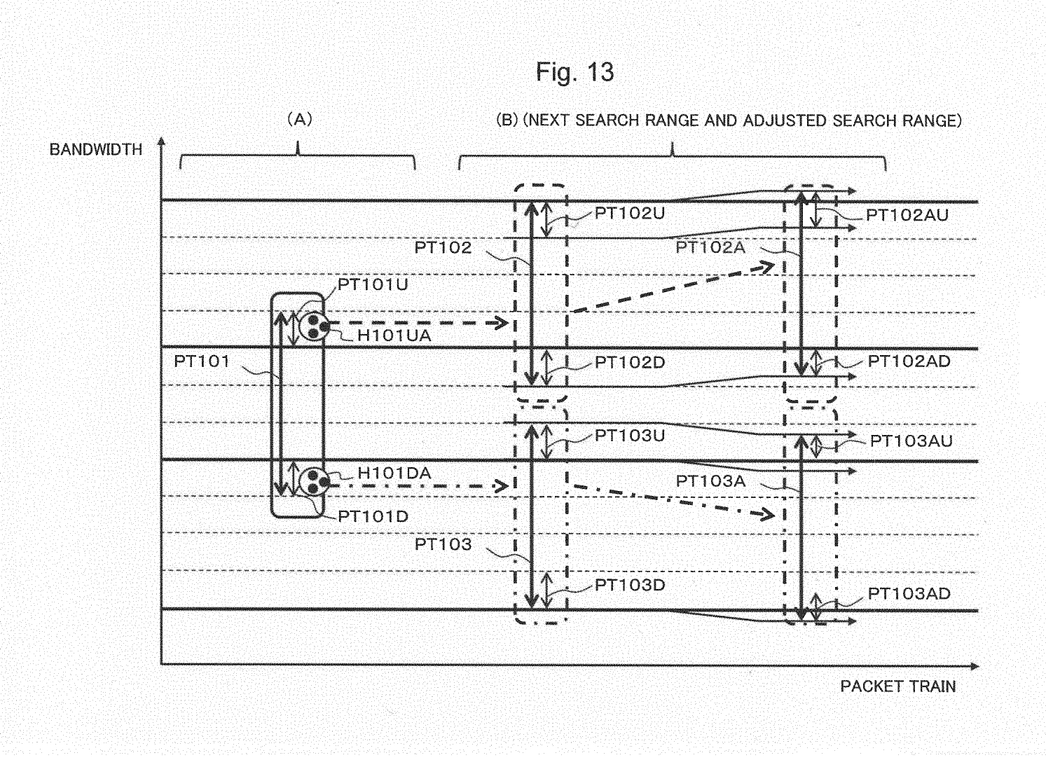

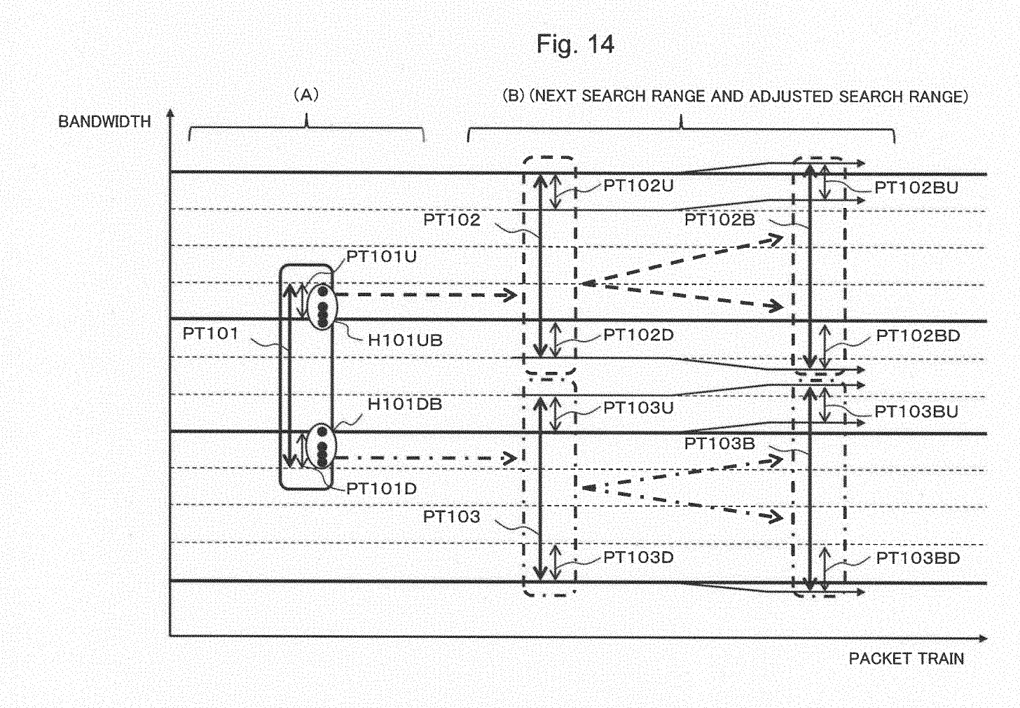

FIGS. 13 and 14 are diagrams illustrating operation examples of the available bandwidth measuring system 200 according to the present example embodiment. Referring to FIGS. 11 to 14, determination of whether or not to adjust a search range, and an adjustment operation performed by the search range adjustment means 44 will be described.

A range (A) in FIG. 13 and a range (A) in FIG. 14 illustrate a packet train PT101 including a plurality of measurement packets. A range (B) in FIG. 13 illustrates PT102 and PT103 shifted from PT101 as next search ranges, and PT102A and PT103A being adjusted search ranges. A range (B) in FIG. 14 illustrates PT102 and PT103 shifted from PT101 as next search ranges, and PT102B and PT103B being adjusted search ranges. The difference between the range (B) in FIG. 13 and the range (B) in FIG. 14 is caused by a difference in an adjustment operation performed by the search range adjustment means 44 in accordance with an estimated value variation range calculated by the estimated value variation range calculation means 42.

First, a case of the determination means 43 determining that a maximum estimated value of estimated values of an available bandwidth of a plurality of PT101s exists in an upper determination section PT101U, and setting PT102 to the search range adjustment means 44 as a next search range will be described.

PT102 is set to the search range adjustment means 44 as a next search range. When an estimated value variation range H101UA calculated by the estimated value variation range calculation means 42 with respect to the upper determination section PT101U exists within a preset first threshold value section, the search range adjustment means 44 adjusts the set search range (S313: Yes). The search range adjustment means 44 adjusts PT102 being the set search range so that the entire search range is shifted to the higher side as illustrated in PT102A [refer to the range (B) in FIG. 13]. Note that the first threshold value section refers to a section in the upper determination section PT101U, being provided so as to have a same upper limit as the upper determination section PT101U. The first threshold value section is used for determination of whether or not estimated values of the available bandwidth are stuck at the upper limit of the upper determination section PT101U. Note that it is assumed that a bandwidth range of the first threshold value section is, for example, one tenth of a bandwidth range of the upper determination section PT101U.

Since the estimated value variation range exists within the first threshold value section, the search range adjustment means 44 determines that the estimated values of the available bandwidth are stuck at the upper limit of the upper determination section PT101U. In this case, the search range adjustment means 44 improves accuracy of the search for the available bandwidth by adjusting an entire next search range to the higher side. Accordingly, the search range adjustment means 44 sets PT102A being a search range obtained by adjusting entire PT102 being the search range to the higher side to the search range setting means 11, and returns to next Step S302 (S315).

When an estimated value variation range H101UB calculated by the estimated value variation range calculation means 42 with respect to the upper determination section PT101U exists beyond the first threshold value section and within a preset second threshold value section, the search range adjustment means 44 adjusts the set search range (S313: Yes). The search range adjustment means 44 adjusts PT102 being the set search range so that the search range is extended as illustrated in PT102B [refer to the range (B) in FIG. 14]. Note that the second threshold value section refers to a section in the upper determination section PT101U, being provided so as to have a same upper limit as the upper determination section PT101U and being wider than the first threshold value section. The second threshold value section is used for determination of an extent of estimated values of the available bandwidth in the upper limit region of the upper determination section PT101U. Note that it is assumed that a bandwidth range of the second threshold value section is, for example, half of the bandwidth range of the upper determination section PT101U.

Since the estimated value variation range exists beyond the first threshold value section and within the second threshold value section, the search range adjustment means 44 determines that the estimated values of the available bandwidth are stuck at the upper limit of the upper determination section PT101U and, at the same time, have a large estimated value variation range. In this case, the search range adjustment means 44 improves accuracy of the search for the available bandwidth by adjusting the next search range so that an upper limit of the search range is extended to the higher side, and a lower limit to the lower side. The search range adjustment means 44 sets a search range PT102B adjusted to extend the search range PT102 to the search range setting means 11, and returns to next Step S302 (S315).

An estimated value variation range being large will be described here. A plurality of measurement packets included in each packet train are influenced by network congestion, and therefore delay times included in reception intervals of measurement packets are not uniform. Specifically, scatter of delay times may become greater depending on a congestion state, thus causing a large estimated value variation range of an available bandwidth calculated from packet sizes and reception intervals.

When the estimated value variation range (unillustrated) calculated by the estimated value variation range calculation means 42 with respect to the upper determination section PT101U does not exist within the preset first threshold value section and exists beyond the second threshold value section, the search range adjustment means 44 adjusts the set search range PT102 (S313: Yes). Since the estimated value variation range does not exist within the first threshold value section and exists beyond the second threshold value section, the search range adjustment means 44 determines that the estimated values of the available bandwidth are not stuck at the upper limit of the upper determination section PT101U and, at the same time, have a large estimated value variation range. In this case, the search range adjustment means 44 improves accuracy of the search for the available bandwidth by making an adjustment to extend only a lower limit of the next search range to the lower side. The search range adjustment means 44 sets a search range PT102C (unillustrated) adjusted to extend only the lower limit of the search range PT102 to the search range setting means 11 and returns to next Step S302 (S315).

When the estimated value variation range (unillustrated) calculated by the estimated value variation range calculation means 42 with respect to the upper determination section PT101U does not exist within the preset first threshold value section and exists within the second threshold value section, the search range adjustment means 44 does not adjust the set search range PT102 (S313: No). Since the estimated value variation range does not exist within the first threshold value section and exists within the second threshold value section, the search range adjustment means 44 determines that the estimated values of the available bandwidth are not stuck at the upper limit of the upper determination section PT101U and, at the same time, have a small estimated value variation range. In this case, the search range adjustment means 44 does not adjust the search range PT102, sets the set search range PT102 to the search range setting means 11, and returns to next Step S302 (S314).

Next, a case of the determination means 43 determining that a minimum estimated value of estimated values of an available bandwidth of respective PT101s exists in a lower determination section PT101D, and setting PT103 to the search range adjustment means 44 as a next search range will be described.

PT103 is set to the search range adjustment means 44 as a next search range. When an estimated value variation range H101DA calculated by the estimated value variation range calculation means 42 with respect to the lower determination section PT101D exists within a preset third threshold value section, the search range adjustment means 44 adjusts the set search range (S313: Yes). Specifically, the search range adjustment means 44 adjusts the set search range PT103 so that the entire search range is shifted to the lower side as illustrated in PT103A [refer to the range (B) in FIG. 14]. Note that the third threshold value section refers to a section in the lower determination section PT101D, being provided so as to have a same lower limit as the lower determination section PT101D. The third threshold value section is used for determination of whether or not estimated values of the available bandwidth are stuck at the lower limit of the lower determination section PT101D. Note that it is assumed that a bandwidth range of the third threshold value section is, for example, one tenth of a bandwidth range of the lower determination section PT101D.

Since the estimated value variation range exists within the third threshold value section, the search range adjustment means 44 determines that the estimated values of the available bandwidth are stuck at the lower limit of the lower determination section PT101D. In this case, the search range adjustment means 44 improves accuracy of the search for the available bandwidth by adjusting the next search range to the lower side. The search range adjustment means 44 sets a search range PT103A obtained by adjusting the entire search range PT103 to the lower side to the search range setting means 11, and returns to next Step S302 (S315).

When an estimated value variation range H101DB calculated by the estimated value variation range calculation means 42 with respect to the lower determination section PT101D exists beyond the third threshold value section and within a preset fourth threshold value section, the search range adjustment means 44 adjusts the set search range (S313: Yes). The search range adjustment means 44 adjusts the set search range PT103 so that the search range extends as illustrated in PT103B [refer to the range (B) in FIG. 14]. Note that the fourth threshold value section refers to a section in the lower determination section PT101D, being provided so as to have a same lower limit as the lower determination section PT101D and being wider than the third threshold value section. The fourth threshold value section is used for determination of an extent of estimated values of the available bandwidth in the lower limit region of the lower determination section PT101D. Note that it is assumed that a bandwidth range of the fourth threshold value section is, for example, half of the bandwidth range of the lower determination section PT101D.

Since the estimated value variation range exists beyond the third threshold value section and within the fourth threshold value section, the search range adjustment means 44 determines that the estimated values of the available bandwidth are stuck at the lower limit of the lower determination section PT101D, and have a large estimated value variation range. In this case, the search range adjustment means 44 improves accuracy of the search for the available bandwidth by adjusting the next search range so that an upper limit of the search range is extended to the higher side, and a lower limit is extended to the lower side. The search range adjustment means 44 sets a search range PT103B adjusted to extend the lower search range PT103 to the search range setting means 11, and returns to next Step S302 (S315).

When the estimated value variation range (unillustrated) calculated by the estimated value variation range calculation means 42 with respect to the lower determination section PT101D does not exist within the preset third threshold value section and exists beyond the fourth threshold value section, the search range adjustment means 44 adjusts set PT103 (S313: Yes). Since the estimated value variation range does not exist within the third threshold value section and exists beyond the fourth threshold value section, the search range adjustment means 44 determines that the estimated values of the available bandwidth are not stuck at the lower limit of the lower determination section PT101D, and have a large estimated value variation range. In this case, the search range adjustment means 44 improves accuracy of the search for the available bandwidth by adjusting the next search range so that only an upper limit of the search range is extended to the higher side. The search range adjustment means 44 sets a search range PT103C (unillustrated) adjusted to extend only the upper limit of PT103 to the search range setting means 11, and returns to next Step S302 (S315).

When the estimated value variation range (unillustrated) calculated by the estimated value variation range calculation means 42 with respect to the lower determination section PT101D does not exist within the preset third threshold value section and exists within the fourth threshold value section, the search range adjustment means 44 does not adjust set PT103 (S313: No). Since the estimated value variation range does not exist within the third threshold value section and exists within the fourth threshold value section, the search range adjustment means 44 determines that the estimated values of the available bandwidth are not stuck at the lower limit of the lower determination section PT101D, and have a small estimated value variation range. In this case, the search range adjustment means 44 does not adjust the next search range PT103, sets the set search range PT103 to the search range setting means 11, and returns to next Step S302 (S314).

Thus, the search range adjustment means 44 determines whether or not to adjust a search range set by the determination means 43, in accordance with an estimated value variation range calculated by the estimated value variation range calculation means 42. The search range adjustment means 44 is able to improve accuracy of a search for an available bandwidth by setting a search range adjusted in accordance with the determination result to the search range setting means 11.

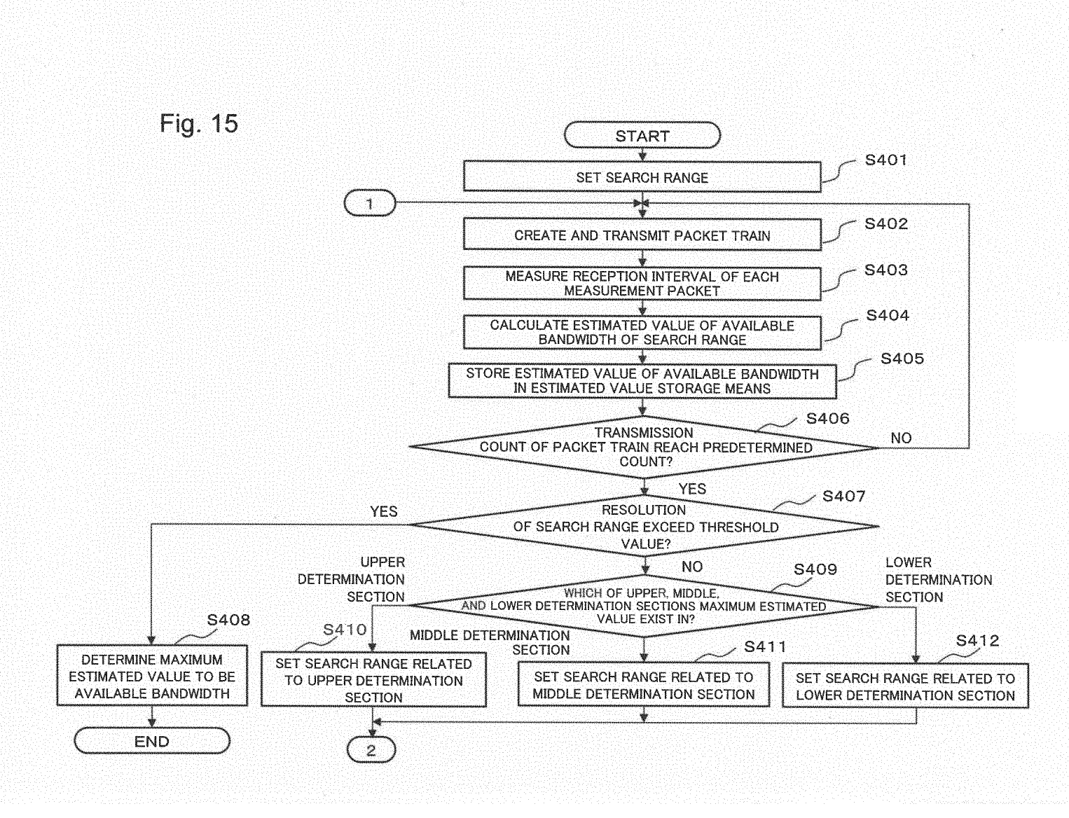

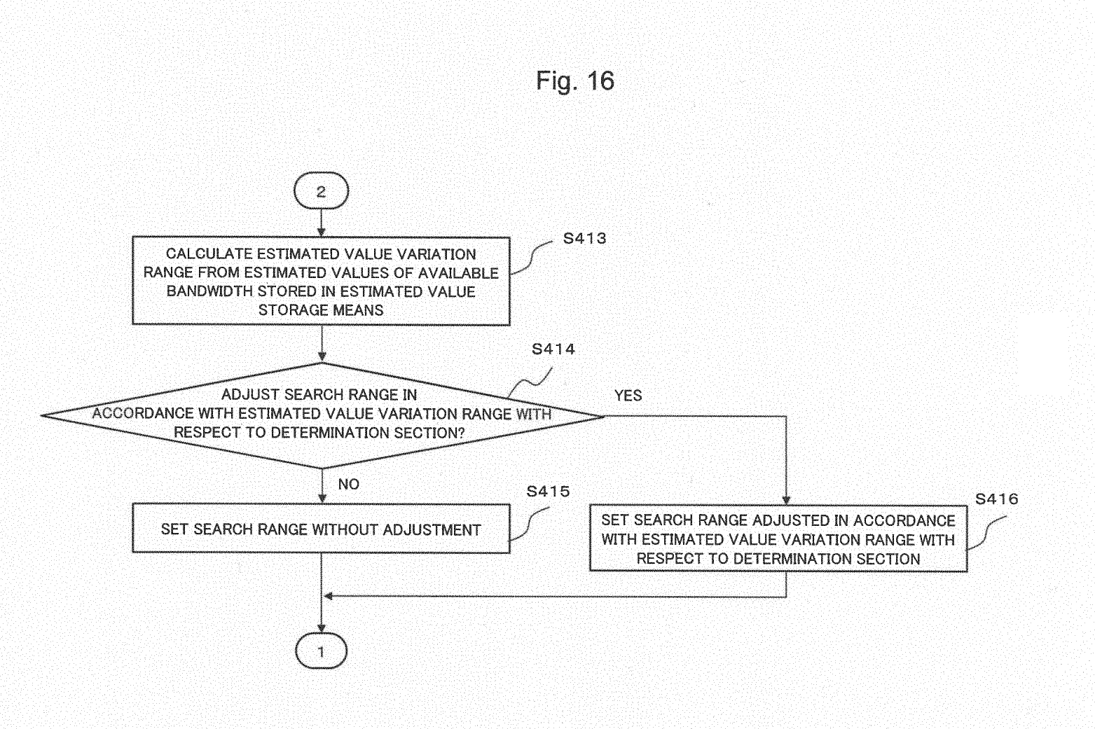

FIGS. 15 and 16 are flowcharts illustrating another operation example of the available bandwidth measuring system 200 according to the present example embodiment. Referring to FIGS. 15 and 16, another operation example of the available bandwidth measuring system 200 will be described.

The determination means 43 sets a search range to the search range setting means 11 through the search range adjustment means 44 (S401). The packet train generation means 12 creates a packet train in accordance with the search range set to the search range setting means 11, and outputs the packet train (S402). The packet train includes a plurality of measurement packets in accordance with the search range set to the search range setting means 11, and the respective measurement packets are output at predetermined transmission intervals.

The reception interval measurement means 21 receives each measurement packet in the packet train output from the packet train generation means 12, and measures a reception interval of each received measurement packet (S403). The estimated value calculation means 22 calculates an estimated value of an available bandwidth from a packet size and a reception interval of each received measurement packet, and outputs the calculated estimated value of the available bandwidth (S404).

The estimated value storage means 41 stores the estimated value of the available bandwidth output by the estimated value calculation means 22 (S405).

The determination means 43 checks whether or not a transmission count of a packet train PT111 reaches a preset predetermined count (S406). When the transmission count of the packet train PT111 does not reach the predetermined count (S406: No), the determination means 43 returns to the processing in Step S402.

When the transmission count of the packet train PT111 reaches the predetermined count (S406: Yes), the determination means 43 transits to processing in Step S407.

The determination means 13 determines whether or not resolution of a search range searched by the packet train PT111 exceeds a predetermined threshold value, in accordance with a number of measurement packets related to PT111 (S407).

When the resolution of the searched search range exceeds the predetermined threshold value (S407: Yes), the determination means 43 performs processing in next Step S408. Specifically, the determination means 43 determines, for example, a maximum estimated value of the estimated values of the available bandwidth of PT111 as the available bandwidth (S408). In this case, the determination means 43 determines the available bandwidth with determination that the available bandwidth can be determined with the estimated values of the available bandwidth of PT111 at predetermined resolution, that is, with predetermined precision. Note that the determination means 43 may determine a mean value, a median value, or a minimum value of the aforementioned estimated values of the available bandwidth as the available bandwidth of the search range.

By contrast, when the resolution of the searched search range does not exceed the predetermined threshold value (S407: No), the determination means 43 determines in which preset determination section a maximum estimated value of the estimated values of the available bandwidth of PT111 exists (S409). In this case, the determination means 43 determines that the predetermined resolution, that is, the predetermined precision cannot be obtained with the estimated values of the available bandwidth of PT111, and continues the search in a divided search range described below.

When the maximum estimated value exists in an upper determination section PT111U (S409: upper determination section), the determination means 43 sets PT112 to the search range adjustment means 44 as a next search range, and transits to processing in Step S413 (S410).

When the maximum estimated value exists in a middle determination section PT111M (S409: middle determination section), the determination means 43 sets PT113 to the search range adjustment means 44 as a next search range, and transits to the processing in Step S413 (S411).

When the maximum estimated value exists in a lower determination section PT111D (S409: lower determination section), the determination means 43 sets PT114 to the search range adjustment means 44 as a next search range, and transits to the processing in Step S413 (S412).

The estimated value variation range calculation means 42 calculates a bandwidth range represented by a maximum estimated value and a minimum estimated value of the estimated values of the available bandwidth stored in the estimated value storage means 41, as an estimated value variation range (S413). The search range adjustment means 44 determines whether or not to adjust the search range set by the determination means 43, in accordance with the estimated value variation range with respect to the determination section (S414).

Thus, the available bandwidth measuring system 200 according to the present example embodiment is able to determine an available bandwidth and search range change, in accordance with estimated values of an available bandwidth calculated by a plurality of packet trains.

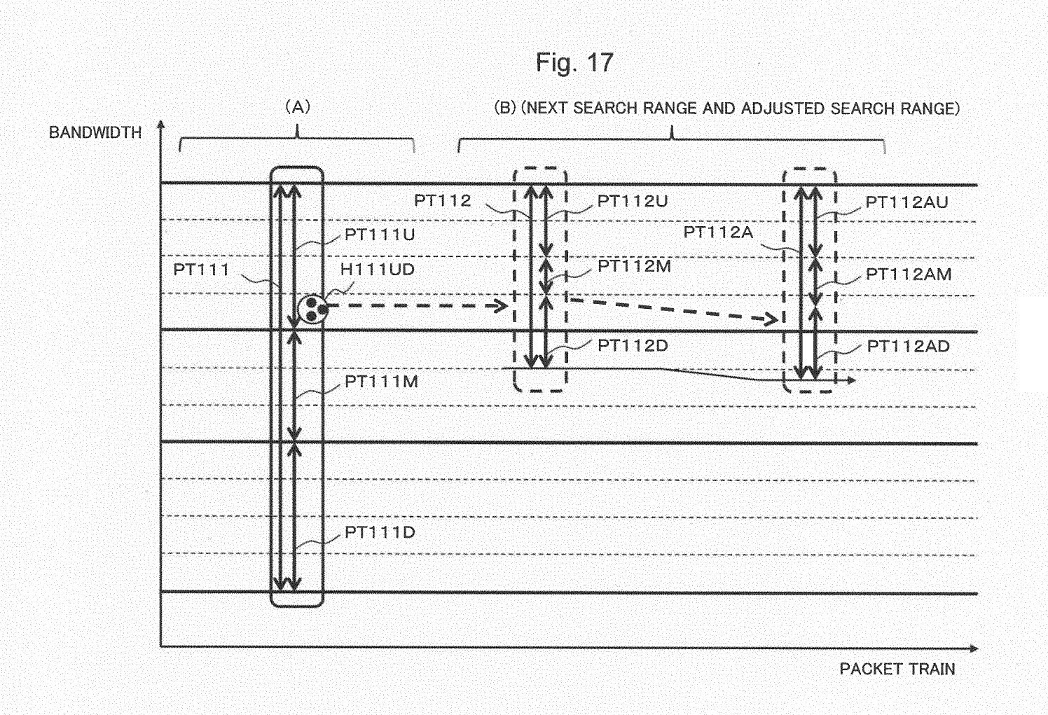

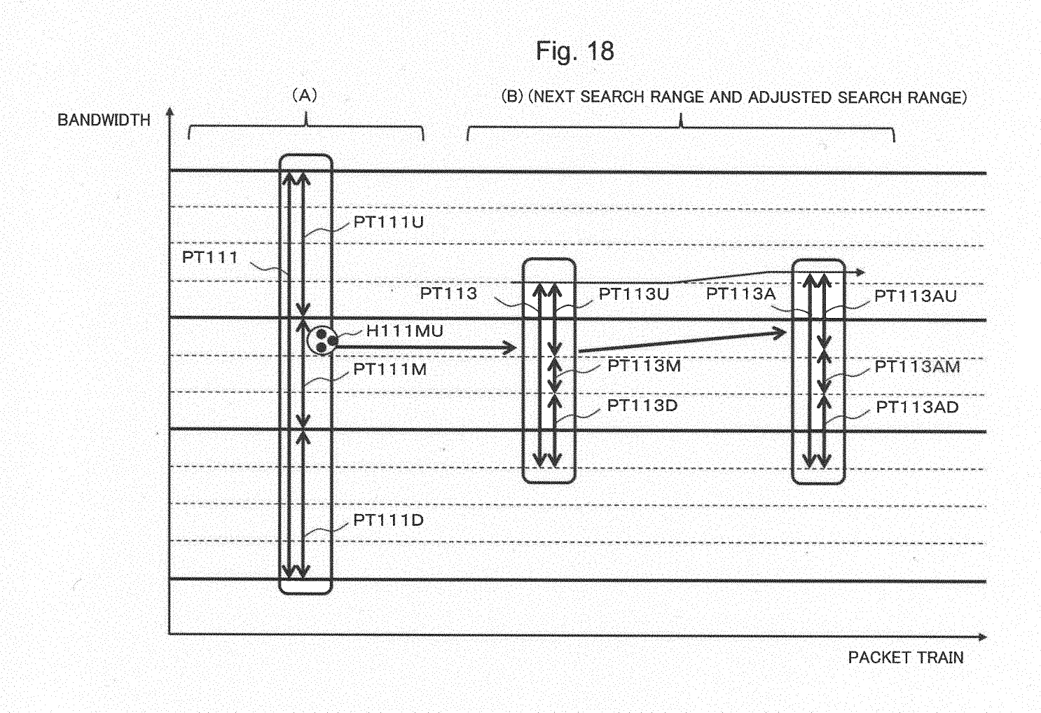

FIGS. 17 and 18 are diagrams illustrating another operation example of the available bandwidth measuring system 200 according to the present example embodiment. Referring to FIGS. 15 to 18, determination of whether or not to adjust a search range, and an adjustment operation performed by the search range adjustment means 44 will be described.

A range (A) in FIG. 17 and a range (A) in FIG. 18 illustrate a packet train PT111 including a plurality of measurement packets. A range (B) in FIG. 17 illustrates PT112 being a next search range obtained by dividing PT111, and adjusted PT112A. A range (B) in FIG. 18 illustrates PT113 being a next search range obtained by dividing PT111, and adjusted PT113A.

First, a case of the determination means 43 determining that a maximum estimated value exists within an upper determination section PT111U, in accordance with estimated values of an available bandwidth of a plurality of packet trains PT111, and setting PT112 to the search range adjustment means 44 as a next search range will be described.

PT112 is set to the search range adjustment means 44 as a next search range. When an estimated value variation range H111UD calculated by the estimated value variation range calculation means 42 with respect to the upper determination section PT111U exists within a preset fifth threshold value section, the search range adjustment means 44 adjusts the set search range (S414: Yes). The search range adjustment means 44 adjusts a lower limit of the set search range PT112 to the lower side as illustrated in PT112A [refer to the range (B) in FIG. 17]. Here, the fifth threshold value section refers to a section in an upper determination section PT111U, being provided so as to have a same lower limit as the upper determination section PT111U. The fifth threshold value section is used for determination of whether or not estimated values of the available bandwidth are stuck at the lower limit of the upper determination section PT111U. Note that it is assumed that a bandwidth range of the fifth threshold value section is, for example, one twentieth of a bandwidth range of the upper determination section PT111U.

Since the estimated value variation range exists within the fifth threshold value section, the search range adjustment means 44 determines that the estimated values of the available bandwidth are stuck at the lower limit of the upper determination section PT111U. In this case, the search range adjustment means 44 improves accuracy of the search for the available bandwidth by adjusting a lower limit of the next search range to the lower side. The search range adjustment means 44 sets PT112A being a search range obtained by adjusting the lower limit of the search range PT112 to the lower side to the search range setting means 11, and returns to next Step S402 (S416).

When the estimated value variation range H111UD calculated by the estimated value variation range calculation means 42 with respect to the upper determination section PT111U exists beyond the preset fifth threshold value section, the search range adjustment means 44 does not adjust the set search range PT112 (S414: No). In other words, since the estimated value variation range exists beyond the fifth threshold value section, the search range adjustment means 44 determines that the estimated values of the available bandwidth are not stuck at the lower limit of the upper determination section PT111U. In this case, the search range adjustment means 44 sets the set search range PT112 to the search range setting means 11, and returns to next Step S402 (S415).

Next, a case of the determination means 43 determining that a maximum estimated value exists within a middle determination section PT111M, in accordance with estimated values of an available bandwidth of a plurality of packet trains PT111, and setting PT113 to the search range adjustment means 44 as a next search range will be described.

PT113 is set to the search range adjustment means 44 as a next search range. When an estimated value variation range H111MU calculated by the estimated value variation range calculation means 42 with respect to the middle determination section PT111M exists within a preset sixth threshold value section, the search range adjustment means 44 adjusts the set search range (S414: Yes). The search range adjustment means 44 adjusts an upper limit of set PT113 to the higher side as illustrated in PT113A [refer to the range (B) in FIG. 18]. Here, the sixth threshold value section refers to a section in the middle determination section PT111M, being provided so as to have a same upper limit as the middle determination section PT111M. The sixth threshold value section is used for determination of whether or not the estimated values of the available bandwidth are stuck at the upper limit of the middle determination section PT111M. Note that it is assumed that a bandwidth range of the sixth threshold value section is, for example, one twentieth of a bandwidth range of the middle determination section PT111M.

Since the estimated value variation range exists within the sixth threshold value section, the search range adjustment means 44 determines that the estimated values of the available bandwidth are stuck at the upper limit of the middle determination section PT111M. In this case, the search range adjustment means 44 improves accuracy of the search for the available bandwidth by adjusting an upper limit of the next search range to the higher side. The search range adjustment means 44 sets a search range PT113A obtained by adjusting the upper limit of the search range PT113 to the higher side to the search range setting means 11, and returns to next Step S402 (S416).

When the estimated value variation range H111MU calculated by the estimated value variation range calculation means 42 with respect to the middle determination section PT111M exists beyond the preset sixth threshold value section, the search range adjustment means 44 does not adjust the set search range PT113 (S414: No). In other words, since the estimated value variation range exists beyond the sixth threshold value section, the search range adjustment means 44 determines that the estimated values of the available bandwidth are not stuck at the upper limit of the middle determination section PT111M. In this case, the search range adjustment means 44 sets the set search range PT113 to the search range setting means 11, and returns to next Step S402 (S415).

The search range adjustment means 44 is able to make a similar adjustment of a search range with respect to the lower limit side of the middle determination section PT111M and the upper limit side of the lower determination section PT111D.

Thus, the search range adjustment means 44 determines whether or not to adjust a search range set by the determination means 43, in accordance with an estimated value variation range calculated by the estimated value variation range calculation means 42. The search range adjustment means 44 adjusts the search range in accordance with the determination result, and sets a search range in which accuracy of a search for an available bandwidth is improved by the adjustment to the search range setting means 11.

As described above, the transmission side device in the available bandwidth measuring system 200 according to the present example embodiment outputs a packet train including a plurality of measurement pallets for measuring an available bandwidth a predetermined number of times, in accordance with a set search range. The receiving side device measures reception intervals of measurement packets in each received packet train, and calculates and outputs an estimated value of the available bandwidth in each packet train. The transmission side device is able to determine an estimated value of the available bandwidth in accordance with a preset determination section, set a next search range, and search for the available bandwidth by shifting or dividing the search range. Additionally, the transmission side device calculates a variation range of estimated values of the available bandwidth, determines whether or not to adjust the search range, and adjusts the search range in accordance with the determination result. The transmission side device is able to improve accuracy of the search for the available bandwidth by adjusting the search range.

As described above, similarly to the first example embodiment, the available bandwidth measuring system 200 according to the present example embodiment is able to improve precision of an available bandwidth by properly changing a search range of the available bandwidth. Additionally, the present example embodiment adjusts the search range of the available bandwidth in accordance with an estimated value variation range, and therefore is able to improve accuracy of the search for the available bandwidth.

Note that a variation range of estimated values, according to the present example embodiment, has been described to be calculated from a bandwidth range represented by a maximum value and a minimum value of estimated values of an available bandwidth. However, the calculation of a variation range of estimated values is not limited to the calculation by a bandwidth range represented by a maximum value and a minimum value. For example, the estimated value variation range may be a bandwidth range represented by a mean value and a standard deviation of estimated values of an available bandwidth calculated by respective packet trains related to a search range. That is to say, the variation range of estimated values has only to be a variation range that enables grasp of a state of estimated values of the available bandwidth. The state of estimated values of the available bandwidth includes, for example, a state in which estimated values are stuck at an upper limit (or a lower limit) of a search range, and a state in which estimated values are not stuck at an upper limit (or a lower limit) of a search range, and an estimated value variation range is large.

Further, respective threshold values used for determination of a state in which estimated values of an available bandwidth are stuck, and a state in which an estimated value variation range is large, according to the present example embodiment, have been described by indicating numerical values with respect to respective determination sections. However, the numerical values indicated for the respective threshold values, according to the present invention, are exemplifications as the respective threshold values, and the respective threshold values are not limited to the indicated numerical values.

Further, the flowcharts and the diagrams illustrated in FIGS. 11 to 18 are exemplifications as operation examples of the available bandwidth measuring system 200 according to the present invention, and the operation of the available bandwidth measuring system according to the present invention is not limited to the illustrations of the flowcharts and the diagrams.

### Third Example Embodiment

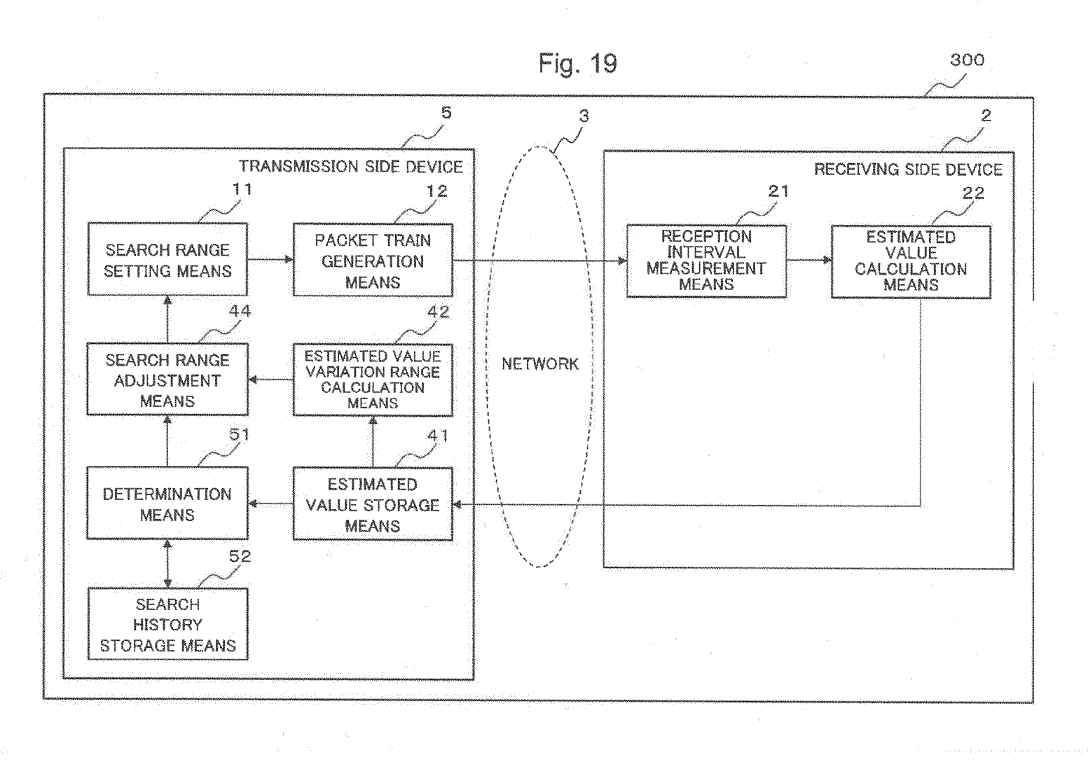

A third example embodiment of the present invention will be described. FIG. 19 is a block diagram illustrating a configuration example of an available bandwidth measuring system 300 according to the third example embodiment of the present invention.

Referring to FIG. 19, a configuration of the available bandwidth measuring system 300 according to the present example embodiment will be described. In the available bandwidth measuring system 300, the transmission side device 4 illustrated in FIG. 10 is changed to a transmission side device 5. The transmission side device 5 differs from the configuration according to the second example embodiment in that a search history storage means 52 is added to the transmission side device 4 illustrated in FIG. 10, and the determination means 43 is changed to a determination means 51. A same designation and a same reference number are hereinafter given to a component same as the second example embodiment, description thereof is omitted, and changes will be described.

The transmission side device 5 includes a search range setting means 11, a packet train generation means 12, an estimated value storage means 41, an estimated value variation range calculation means 42, a search range adjustment means 44, the determination means 51, and the search history storage means 52. A search range for measuring an available bandwidth from the transmission side device 5 to a receiving side device 2 is set to the search range setting means 11 by the search range adjustment means 44. The packet train generation means 12 generates a packet train including a plurality of measurement packets, in accordance with a search range set to the search range setting means 11, and outputs the respective measurement packets at predetermined transmission intervals.

The estimated value storage means 41 stores an estimated value of an available bandwidth notified from the receiving side device 2. The estimated value variation range calculation means 42 calculates a variation range of estimated values of the available bandwidth stored in the estimated value storage means 41. The determination means 51 determines an available bandwidth and a search range in accordance with an estimated value of the available bandwidth stored in the estimated value storage means 41, and search information stored in the search history storage means 52. Here, the search history storage means 52 stores time information at determination of an available bandwidth toward the receiving side device 2 by the determination means 51, determination information of the determined available bandwidth, and setting information of a search range as search history information. The determination means 51 sets a search range to the search range adjustment means 44 in accordance with the determination result. The search range adjustment means 44 adjusts a search range set by the determination means 51, in accordance with an estimated value variation range from the estimated value variation range calculation means 42, and sets the adjusted search range to the search range setting means 11.

The receiving side device 2 is not changed from the second example embodiment, and therefore description thereof is omitted. A setting operation of a search range by the determination means 51, resulting from the search history storage means 52 being provided for the transmission side device 5, will be described.

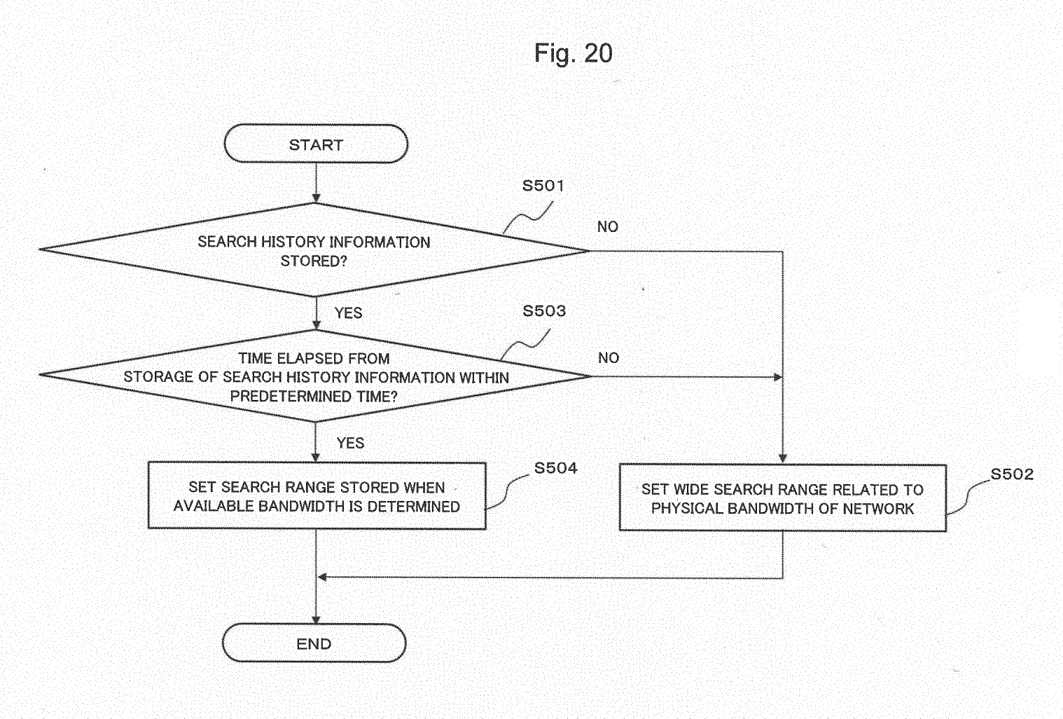

FIG. 20 is a flowchart illustrating an operation example of the available bandwidth measuring system 300 according to the present example embodiment. Referring to FIG. 20, a setting operation of a search range related to the search history storage means 52, being performed by the determination means 51 in the available bandwidth measuring system 300, will be described.

The determination means 51 checks whether or not the search history storage means 52 stores search history information (S501). When search history information is not stored (S501: No), the determination means 51 sets a wideband search range related to an upper limit of a physical bandwidth of a network 3 toward the receiving side device 2 (S502). By the determination means 51 setting a wideband search range, and searching the search range by the aforementioned division method, an available bandwidth toward the receiving side device 2 for which the available bandwidth has not been determined can be efficiently searched.

By contrast, when search history information is stored (S501: Yes), the determination means 51 checks whether or not a time elapsed from storage of the search history information with respect to the receiving side device 2 is within a predetermined time (S503). When the time elapsed from the storage of the search history information is not within the predetermined time (S503: No), the determination means 51 transits to the processing in Step S502. Since the predetermined time has elapsed from determination of the available bandwidth, the determination means 51 determines that the available bandwidth greatly differs from a preceding available bandwidth toward the receiving side device 2. Accordingly, by setting a wideband search range without depending on the preceding search history information, the determination means 51 is able to efficiently search for the available bandwidth toward the receiving side device 2.

When the time elapsed from the storage of the search history information is within the predetermined time (S503: Yes), the determination means 51 sets a search range stored when the available bandwidth is determined (S504). Since the time elapsed from the determination of the available bandwidth is within the predetermined time, the determination means 51 determines that the available bandwidth toward the receiving side device 2 does not greatly differ from the preceding available bandwidth. Accordingly, by setting a search range in accordance with set information of a preceding search range, and searching the search range by the aforementioned shift method, the determination means 51 is able to efficiently search for the available bandwidth toward the receiving side device 2.

Thus, in a search for an available bandwidth toward the receiving side device 2, the determination means 51 is able to set a search range in accordance with existence or nonexistence of search history information stored in the search history storage means 52 and an elapsed time from storage of the search history information, and effectively make the search for the available bandwidth. Note that when the available bandwidth toward the receiving side device is determined, the determination means 51 may cause the search history storage means 52 to store time information at the time, determination information about the determined available bandwidth, and set information of the search range, as search history information. Further, an operation of the available bandwidth measuring processing after the determination means 51 sets a search range to the search range adjustment means 44 has been described in the aforementioned example embodiments, and therefore description thereof is omitted.

As described above, the transmission side device in the available bandwidth measuring system 300 according to the present example embodiment outputs a plurality of packet trains measuring an available bandwidth, in accordance with a set search range. The receiving side device measures reception intervals of measurement packets in received packet trains, and outputs estimated values of the available bandwidth related to the respective packet trains. The transmission side device is able to determine an estimated value of the available bandwidth in accordance with a preset determination section, set a next search range, and shift or divide the search range to search for the available bandwidth. Then, the transmission side device calculates an estimated value variation range of the available bandwidth, determines whether or not to adjust the search range, and adjusts the search range in accordance with the determination result. The transmission side device is able to improve accuracy of the search for the available bandwidth by adjusting the search range. Additionally, the transmission side device is able to efficiently search for the available bandwidth by setting a search range in accordance with whether or not search history information is stored in the search history storage means and an elapsed time from storage of the search history information. For example, the present example embodiment is able to shorten a measurement time of the available bandwidth.

As described above, similarly to the aforementioned example embodiments, the available bandwidth measuring system 300 according to the present example embodiment is able to improve precision of an available bandwidth by properly changing a search range of the available bandwidth. Additionally, the available bandwidth measuring system 300 according to the present example embodiment sets a search range of an available bandwidth in accordance with search history information, and therefore is able to effectively search for the available bandwidth.

Note that, in setting a wideband search range, according to the present example embodiment, a search for an available bandwidth has been described to be performed by the division method. However, in setting a wideband search range, the search for the available bandwidth is not limited to use of the division method. The determination means may start a search by the division method, and change the method to the shift method to search for the available bandwidth. At this time, the determination means may search for the available bandwidth by the division method by dividing a search range into search ranges in which preset predetermined resolution is obtained, and subsequently change the method to the shift method to search for the available bandwidth.

Further, the present example embodiment has been described to search for an available bandwidth by the shift method when search history information is stored. However, when a search range is changed by shifting a preset predetermined number of times, the determination means may extend the search range by setting a wideband search range. In that case, a search for an available bandwidth by the division method may be performed.

Further, the determination means according to the present example embodiment has been described to cause the search history storage means to store search history information. However, storage of search history information is not limited to be performed by the determination means. Specifically, the search range adjustment means may determine adjustment of a search range, and the search range adjustment means may further cause the search history storage means to store adjustment information of the determined search range as search history information. At this time, when adjustment information of the search history information is stored, the determination means may more effectively make a search for an available bandwidth by setting a search range in accordance with the adjustment information of the search range.

Further, the flowchart illustrated in FIG. 20 is an exemplification as an operation example of the available bandwidth measuring system 300 according to the present invention, and the operation of the available bandwidth measuring system according to the present invention is not limited to the illustration of the flowchart.

Note that the present invention is not limited to the respective aforementioned example embodiments, and various changes and modifications may be made without departing from the spirit and scope of the present invention.

For example, the estimated value storage means and the estimated value variation range calculation means described in the second example embodiment may be included in the receiving side device. At this time, an estimated value of an available bandwidth stored in the estimated value storage means and an estimated value variation range calculated by the estimated value variation range calculation means may be output to the transmission side device.

Further, the search history storage means described in the third example embodiment may be included in the transmission side device according to the first example embodiment. The search for an available bandwidth described in the third example embodiment can be effectively performed even when the search history storage means is included in the transmission side device according to the first example embodiment.

Further, a direction of an arrow in the drawings indicates an example, and does not limit a signal direction between blocks.

Further, the transmission side device and the receiving side device in the available bandwidth measuring system according to the respective aforementioned example embodiments are composed of devices such as a server computer, a personal computer, a personal digital assistant (PDA), a tablet terminal, a smartphone, a mobile phone, and a fixed phone. Further, the transmission side device and the receiving side device may also be composed of devices such as an on-the-street multimedia terminal, an onboard terminal, a network connectable television, a network connectable set-top box, a network connectable printer, and a network connectable scanner. The transmission side device and the receiving side device are not limited to the devices described above, and may be another device having a function of exchanging information with the outside.

Further, the available bandwidth measuring processing by the transmission side device and the receiving side device in the available bandwidth measuring system according to the respective aforementioned example embodiments may be performed by software using computers (unillustrated) included in the transmission side device and the receiving side device. That is to say, the available bandwidth measuring processing may be provided by a computer program performing the processing, the program being read and executed by a central processing unit (CPU).

Note that the program may be stored in a semiconductor storage device such as a read only memory (ROM), a random access memory (RAM), and a flash memory, and a non-transitory medium such as an optical disk, a magnetic disk, and a magneto-optical disk.

The whole or part of the example embodiments disclosed above can be described as, but not limited to, the following supplementary notes.

### (Supplementary Note 1)

An available bandwidth measuring system comprising:

search range setting means to which a first search range provided with a first determination section determining whether or not to change the first search range searched for an available bandwidth to a second search range is set;

packet transmission means that generates a packet train including a plurality of measurement packets having successively increasing packet sizes, in accordance with the first search range, and transmits the plurality of measurement packets at predetermined transmission intervals;

reception interval measurement means that receives the packet train and measures reception intervals of the plurality of measurement packets;

estimated value calculation means that calculates an estimated value of the available bandwidth in accordance with the packet sizes and a measurement result of the reception intervals of the plurality of measurement packets, and outputs the estimated value; and

determination means that
determines whether or not to change the first search range to the second search range, in accordance with the first determination section and the estimated value, and,
in accordance with a determination result,
sets a change to the second search range, to the search range setting means, and continue searching for the available bandwidth, or
makes an available bandwidth determination of determining the estimated value to be the available bandwidth.

### (Supplementary Note 2)

The available bandwidth measuring system according to Supplementary Note 1, wherein

the determination means

determines whether or not the estimated value is included in the first determination section, and,

when the estimated value is included in the first determination section, sets a change from the first search range to the second search range provided with a second determination section determining whether or not to change the second search range to a third search range, to the search range setting means, and continues searching for the available bandwidth, and,

when the estimated value is not included in the first determination section, makes the available bandwidth determination.

### (Supplementary Note 3)

The available bandwidth measuring system according to Supplementary Note 1 or 2, wherein

the first search range and the second search range include bandwidths overlapping with one another.

### (Supplementary Note 4)

The available bandwidth measuring system according to any one of Supplementary Notes 1 to 3, wherein

the first determination section includes a first upper determination section and a first lower determination section,

the second search range includes a second upper search range and a second lower search range, and

the determination means

makes a change to the second upper search range when the estimated value is included in the first upper determination section, and

makes a change to the second lower search range when the estimated value is included in the first lower determination section.

### (Supplementary Note 5)

The available bandwidth measuring system according to Supplementary Note 4, wherein

the first determination section includes the first upper determination section on an upper limit side of the first search range, and includes the first lower determination section on a lower limit side,

the first upper determination section is included in a lower limit side of the second upper search range, and

the first lower determination section is included in an upper limit side of the second lower search range.

### (Supplementary Note 6)

The available bandwidth measuring system according to Supplementary Note 5, wherein

an upper limit side of an overlapping range of the first search range and the second upper search range matches the first upper determination section, and the second determination section on a lower limit side of the second upper search range is provided on a lower limit side of the overlapping range excluding the first upper determination section, without overlapping with the first upper determination section, and

a lower limit side of an overlapping range of the first search range and the second lower search range matches the first lower determination section, and the second determination section on an upper limit side of the second lower search range is provided on an upper limit side of the overlapping range excluding the first lower determination section, without overlapping with the first lower determination section.

### (Supplementary Note 7)

The available bandwidth measuring system according to Supplementary Note 6, further comprising:

estimated value storage means that stores the respective estimated values calculated by the packet train being transmitted a predetermined number of times;

estimated value variation range calculation means that calculates an estimated value variation range in accordance with the estimated values stored in the estimated value storage means; and

search range adjustment means that determines whether to, in accordance with the estimated value variation range, adjust the search range set by the determination means, and, in accordance with a determination result, sets an adjusted search range to the search range setting means, wherein

the search range adjustment means

adjusts the entire second upper search range to a higher range, when the estimated value variation range exists within a first threshold value section in the first upper determination section,

adjusts an upper limit of the second upper search range to a higher range and adjusts a lower limit to a lower range, when the estimated value variation range exists beyond a second threshold value section in the first upper determination section,

adjusts the entire second lower search range to a lower range, when the estimated value variation range exists within a third threshold value section in the first lower determination section, and,

adjusts an upper limit of the second lower search range to a higher range and adjusts a lower limit to a lower range, when the estimated value variation range exists beyond a fourth threshold value section in the first lower determination section.

### (Supplementary Note 8)

The available bandwidth measuring system according to any one of Supplementary Notes 2 to 7, wherein,

when a number of change settings of the search range exceeds a predetermined threshold value,

the determination means searches for the available bandwidth with an upper limit and a lower limit of a physical bandwidth of a network being a target of a search for the available bandwidth as a search range before division.

### (Supplementary Note 9)

The available bandwidth measuring system according to any one of Supplementary Notes 2 to 7, wherein,

when a number of change settings of the search range exceeds a predetermined threshold value,

the determination means

searches for the available bandwidth with a preset upper limit and a preset lower limit as a search range before division.

### (Supplementary Note 10)

The available bandwidth measuring system according to Supplementary Note 1, wherein,

by the determination means determining which of a plurality of second divided search ranges being the divided second search range the first search range is changed to, the first search range provided with a plurality of first divided determination sections of the first determination section related to the plurality of second divided search ranges is set to the search range setting means, and

the determination means

determines which of the plurality of second divided search ranges the first search range being a division source of the second search range is changed to, in accordance with the plurality of first divided determination sections and the estimated value, sets a change to one of the plurality of second divided search ranges, to the search range setting means, in accordance with a determination result, and continues searching for the available bandwidth.

### (Supplementary Note 11)

The available bandwidth measuring system according to Supplementary Note 10, wherein

the determination means

determines which of the plurality of first divided determination sections the estimated value is included in,

sets a change from the first search range to the second divided search range related to the first divided determination section including the estimated value, to the search range setting means,

continues searching for the available bandwidth, and,

when resolution of a search bandwidth of the plurality of measurement packets included in the packet train exceeds a predetermined threshold value, makes the available bandwidth determination.

### (Supplementary Note 12)

The available bandwidth measuring system according to Supplementary Note 10 or 11, wherein

the determination means

determines an upper limit and a lower limit of the first search range to be an upper limit and a lower limit of a physical bandwidth of a network being a target of a search for the available bandwidth.

### (Supplementary Note 13)

The available bandwidth measuring system according to Supplementary Note 10 or 11, wherein

the determination means

determines an upper limit and a lower limit of the first search range to be a preset upper limit and a preset lower limit.

### (Supplementary Note 14)

The available bandwidth measuring system according to any one of Supplementary Notes 10 to 13, wherein

the respective plurality of second divided search ranges include side-by-side bandwidths overlapping with one another.

### (Supplementary Note 15)

The available bandwidth measuring system according to any one of Supplementary Notes 10 to 14, further comprising:

estimated value storage means that stores the respective estimated values calculated by the packet train being transmitted a predetermined number of times;

estimated value variation range calculation means that calculates an estimated value variation range in accordance with the estimated values stored in the estimated value storage means; and

search range adjustment means that determines whether to, in accordance with the estimated value variation range, adjust the search range set by the determination means, and, in accordance with a determination result, sets an adjusted search range to the search range setting means, wherein

the search range adjustment means

adjusts a lower limit of the second divided search range related to the plurality of first divided determination sections to a lower range, when the estimated value variation range exists within a fifth threshold value section on a lower limit side of the plurality of first divided determination sections, and

adjusts an upper limit of the second divided search range related to the plurality of first divided determination sections to a higher range, when the estimated value variation range exists within a sixth threshold value section on an upper limit side of the plurality of first divided determination sections.

### (Supplementary Note 16)

The available bandwidth measuring system according to any one of Supplementary Notes 11 to 15, wherein,

when resolution of the search range exceeds a predetermined threshold value,

the determination means

shifts a next search range to a higher side or a lower side, and searches for the available bandwidth.

### (Supplementary Note 17)

The available bandwidth measuring system according to Supplementary Note 7 or 15, wherein

the determination means

makes a change of the search range, and the available bandwidth determination, in accordance with a maximum value of the estimated values stored in the estimated value storage means.

### (Supplementary Note 18)

The available bandwidth measuring system according to Supplementary Note 7 or 15, wherein

the determination means

makes a change of the search range, and the available bandwidth determination, in accordance with a mean value, a median value, or a minimum value of the estimated values stored in the estimated value storage means.

### (Supplementary Note 19)

The available bandwidth measuring system according to any one of Supplementary Notes 7, 15, 17, and 18, wherein

the estimated value variation range calculation means

calculates a bandwidth range represented by a maximum value and a minimum value of the estimated values stored in the estimated value storage means as an estimated value variation range.

### (Supplementary Note 20)

The available bandwidth measuring system according to any one of Supplementary Notes 7, 15, 17, and 18, wherein

the estimated value variation range calculation means

calculates a bandwidth range represented by a mean value and a standard deviation of the estimated values stored in the estimated value storage means as an estimated value variation range.

### (Supplementary Note 21)

The available bandwidth measuring system according to any one of

Supplementary Notes 1 to 20, further comprising search history storage means caused by the determination means to store time information when the available bandwidth is determined, determination information of the available bandwidth, and set information of a search range in which the available bandwidth is determined, as search history information, wherein

the determination means sets the first search range and the first determination section in accordance with the search history information.

### (Supplementary Note 22)

The available bandwidth measuring system according to Supplementary Note 21, wherein,

when the search history storage means does not store the search history information, or when a predetermined time elapses from storage of the search history information,

the determination means

searches a search range before division for the available bandwidth, the search range before division being defined as the first search range with an upper limit and a lower limit thereof being an upper limit and a lower limit of a physical bandwidth of a network being a target of a search for the available bandwidth.

### (Supplementary Note 23)

The available bandwidth measuring system according to Supplementary Note 22, wherein,

when the search history storage means stores the search history information and a time elapsed from storage of the search history information is within a predetermined time,

the determination means

sets the first search range in accordance with the setting information.

### (Supplementary Note 24)

The available bandwidth measuring system according to any one of Supplementary Notes 21 to 23, wherein

the search range adjustment means

causes the search history storage means to store the search history information added with adjustment information of the search range, and,

when the search history information stored in the search history storage means includes the adjustment information,

the determination means

sets the first search range in accordance with the adjustment information.

### (Supplementary Note 25)

An available bandwidth measuring method comprising:

setting a first search range provided with a first determination section determining whether or not to change the first search range searched for an available bandwidth to a second search range;

generating a packet train including a plurality of measurement packets having successively increasing packet sizes, in accordance with the first search range, and transmitting the plurality of measurement packets at predetermined transmission intervals;

receiving the packet train and measuring reception intervals of the plurality of measurement packets;

calculating an estimated value of the available bandwidth in accordance with the packet sizes and a measurement result of the reception intervals of the plurality of measurement packets, and outputting the estimated value; and

determining whether or not to change the first search range to the second search range, in accordance with the first determination section and the estimated value, and, in accordance with a determination result, setting a change to the second search range and continuing searching for the available bandwidth, or making an available bandwidth determination of determining the estimated value to be the available bandwidth.

### (Supplementary Note 26)

The available bandwidth measuring method according to Supplementary Note 25, further including:

determining whether or not the estimated value is included in the first determination section; and,

when the estimated value is included in the first determination section, setting a change from the first search range to the second search range provided with a second determination section determining whether or not to change the second search range to a third search range, and continuing searching for the available bandwidth, and,

when the estimated value is not included in the first determination section, making the available bandwidth determination.

### (Supplementary Note 27)

The available bandwidth measuring method according to Supplementary Note 26, further including:

setting the first search range provided with a plurality of first divided determination sections of the first determination section related to a plurality of second divided search ranges, the first divided determination sections determining which of the plurality of second divided search ranges being the divided second search range the first search range is changed to; and

determining which of the plurality of second divided search ranges the first search range is changed to, in accordance with the plurality of first divided determination sections and the estimated value, setting a change to one of the plurality of second divided search ranges, in accordance with a determination result, and continuing searching for the available bandwidth.

### (Supplementary Note 28)

The available bandwidth measuring method according to Supplementary Note 27, further including:

determining which of the plurality of first divided determination sections the estimated value is included in;

setting a change from the first search range to the second divided search range related to the first divided determination section including the estimated value;

continuing searching for the available bandwidth; and,

when resolution of a search bandwidth of the plurality of measurement packets included in the packet train exceeds a predetermined threshold value, making the available bandwidth determination.

### (Supplementary Note 29)

A transmission side device comprising:

search range setting means to which a first search range provided with a first determination section determining whether or not to change the first search range searched for an available bandwidth to a second search range is set;

packet transmission means that generates a packet train including a plurality of measurement packets having successively increasing packet sizes, in accordance with the first search range, and transmits the plurality of measurement packets at predetermined transmission intervals; and

determination means that
receives the packet train,
measures reception intervals of the plurality of measurement packets,
calculates an estimated value of the available bandwidth in accordance with the packet sizes and a measurement result of the reception intervals of the plurality of measurement packets,
determines whether or not to change the first search range to the second search range, in accordance with the output estimated value and the first determination section, and,
in accordance with a determination result,
sets a change to the second search range, to the search range setting means, and continues searching for the available bandwidth, or
makes an available bandwidth determination of determining the estimated value to be the available bandwidth.

### (Supplementary Note 30)

A receiving side device comprising:

reception interval measurement means that receives, when a packet train including a plurality of measurement packets having successively increasing packet sizes is generated in accordance with a first search range searched for an available bandwidth, the packet train in which the plurality of measurement packets are transmitted at predetermined transmission intervals, and measures reception intervals of the plurality of measurement packets; and

estimated value calculation means that calculates an estimated value of the available bandwidth in accordance with the packet sizes and a measurement result of the reception intervals of the plurality of measurement packets, and outputs the estimated value.

### (Supplementary Note 31)

A transmission side device control program that causes a computer included in a transmission side device to operate as:

search range setting means to which a first search range provided with a first determination section determining whether or not to change the first search range searched for an available bandwidth to a second search range is set;

packet transmission means that generates a packet train including a plurality of measurement packets having successively increasing packet sizes, in accordance with the first search range, and transmits the plurality of measurement packets at predetermined transmission intervals; and

determination means that
receives the packet train,
measures reception intervals of the plurality of measurement packets,
calculates an estimated value of the available bandwidth in accordance with the packet sizes and a measurement result of the reception intervals of the plurality of measurement packets,
determines whether or not to change the first search range to the second search range, in accordance with the output estimated value and the first determination section, and,
in accordance with a determination result,
sets a change to the second search range, to the search range setting means, and continues searching for the available bandwidth, or
makes an available bandwidth determination of determining the estimated value to be the available bandwidth.

### (Supplementary Note 32)

A receiving side device control program causing a computer included in a receiving side device to operate as:

reception interval measurement means that receives, when a packet train including a plurality of measurement packets having successively increasing packet sizes is generated in accordance with a first search range searched for an available bandwidth, the packet train in which the plurality of measurement packets are transmitted at predetermined transmission intervals, and measures reception intervals of the plurality of measurement packets; and

estimated value calculation means that calculates an estimated value of the available bandwidth in accordance with the packet sizes and a measurement result of the reception intervals of the plurality of measurement packets, and outputs the estimated value.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2015-008234, filed on Jan. 20, 2015, the disclosure of which is incorporated herein in its entirety by reference.

### REFERENCE SIGNS LIST

1, 4, 5 Transmission side device
2 Receiving side device
3 Network
11 Search range setting means
12 Packet train generation means
13, 43, 51 Determination means
21 Reception interval measurement means
22 Estimated value calculation means
41 Estimated value storage means
42 Estimated value variation range calculation means
44 Search range adjustment means
52 Search history storage means
100, 200, 300 Available bandwidth measuring system

1. An available bandwidth measuring system comprising:
a search range setting unit to which a first search range provided with a first determination section determining whether or not to change the first search range searched for an available bandwidth to a second search range is set;
a packet transmission unit that generates a packet train including a plurality of measurement packets having successively increasing packet sizes, in accordance with the first search range, and transmits the plurality of measurement packets at predetermined transmission intervals;
a reception interval measurement unit that receives the packet train and measures reception intervals of the plurality of measurement packets;
an estimated value calculation unit that calculates an estimated value of the available bandwidth in accordance with the packet sizes and a measurement result of the reception intervals of the plurality of measurement packets, and outputs the estimated value; and
a determination unit that
determines whether or not to change the first search range to the second search range, in accordance with the first determination section and the estimated value, and,
in accordance with a determination result,
sets a change to the second search range, to the search range setting unit, and continue searching for the available bandwidth, or
makes an available bandwidth determination of determining the estimated value to be the available bandwidth.

2. The available bandwidth measuring system according to claim 1, wherein
the determination unit
determines whether or not the estimated value is included in the first determination section, and,
when the estimated value is included in the first determination section, sets a change from the first search range to the second search range provided with a second determination section determining whether or not to change the second search range to a third search range, to the search range setting unit, and continues searching for the available bandwidth, and,
when the estimated value is not included in the first determination section, makes the available bandwidth determination.

3. The available bandwidth measuring system according to claim 1, wherein
the first search range and the second search range include bandwidths overlapping with one another.

4. The available bandwidth measuring system according to claim 1, wherein
the first determination section includes a first upper determination section and a first lower determination section,
the second search range includes a second upper search range and a second lower search range, and
the determination unit
makes a change to the second upper search range when the estimated value is included in the first upper determination section, and
makes a change to the second lower search range when the estimated value is included in the first lower determination section.

5. The available bandwidth measuring system according to claim 4, wherein
the first determination section includes the first upper determination section on an upper limit side of the first search range, and includes the first lower determination section on a lower limit side,
the first upper determination section is included in a lower limit side of the second upper search range, and
the first lower determination section is included in an upper limit side of the second lower search range.

6. The available bandwidth measuring system according to claim 5, wherein
an upper limit side of an overlapping range of the first search range and the second upper search range matches the first upper determination section, and the second determination section on a lower limit side of the second upper search range is provided on a lower limit side of the overlapping range excluding the first upper determination section, without overlapping with the first upper determination section, and
a lower limit side of an overlapping range of the first search range and the second lower search range matches the first lower determination section, and the second determination section on an upper limit side of the second lower search range is provided on an upper limit side of the overlapping range excluding the first lower determination section, without overlapping with the first lower determination section.

7. The available bandwidth measuring system according to claim 6, further comprising:
an estimated value storage unit that stores the respective estimated values calculated by the packet train being transmitted a predetermined number of times;
an estimated value variation range calculation unit that calculates an estimated value variation range in accordance with the estimated values stored in the estimated value storage unit; and
a search range adjustment unit that determines whether to, in accordance with the estimated value variation range, adjust the search range set by the determination unit, and, in accordance with a determination result, sets an adjusted search range to the search range setting unit, wherein
the search range adjustment unit
adjusts the entire second upper search range to a higher range, when the estimated value variation range exists within a first threshold value section in the first upper determination section,
adjusts an upper limit of the second upper search range to a higher range and adjusts a lower limit to a lower range, when the estimated value variation range exists beyond a second threshold value section in the first upper determination section,
adjusts the entire second lower search range to a lower range, when the estimated value variation range exists within a third threshold value section in the first lower determination section, and,
adjusts an upper limit of the second lower search range to a higher range and adjusts a lower limit to a lower range, when the estimated value variation range exists beyond a fourth threshold value section in the first lower determination section.

8. The available bandwidth measuring system according to claim 2, wherein,
when a number of change settings of the search range exceeds a predetermined threshold value,
the determination unit searches for the available bandwidth with an upper limit and a lower limit of a physical bandwidth of a network being a target of a search for the available bandwidth as a search range before division.

9. The available bandwidth measuring system according to claim 1, wherein,
by the determination unit determining which of a plurality of second divided search ranges being the divided second search range the first search range is changed to, the first search range provided with a plurality of first divided determination sections of the first determination section related to the plurality of second divided search ranges is set to the search range setting unit, and
the determination unit
determines which of the plurality of second divided search ranges the first search range being a division source of the second search range is changed to, in accordance with the plurality of first divided determination sections and the estimated value, sets a change to one of the plurality of second divided search ranges, to the search range setting unit, in accordance with a determination result, and continues searching for the available bandwidth.

10. The available bandwidth measuring system according to claim 9, wherein
the determination unit
determines which of the plurality of first divided determination sections the estimated value is included in,
sets a change from the first search range to the second divided search range related to the first divided determination section including the estimated value, to the search range setting unit,
continues searching for the available bandwidth, and,
when resolution of a search bandwidth of the plurality of measurement packets included in the packet train exceeds a predetermined threshold value, makes the available bandwidth determination.

11. The available bandwidth measuring system according to claim 9, wherein
the determination unit
determines an upper limit and a lower limit of the first search range to be an upper limit and a lower limit of a physical bandwidth of a network being a target of a search for the available bandwidth, or to be a preset upper limit and a preset lower limit.

12. The available bandwidth measuring system according to claim 9, wherein
the respective plurality of second divided search ranges include side-by-side bandwidths overlapping with one another.

13. The available bandwidth measuring system according to claim 9, further comprising:
an estimated value storage unit that stores the respective estimated values calculated by the packet train being transmitted a predetermined number of times;
an estimated value variation range calculation unit that calculates an estimated value variation range in accordance with the estimated values stored in the estimated value storage unit; and
a search range adjustment unit that determines whether to, in accordance with the estimated value variation range, adjust the search range set by the determination unit, and, in accordance with a determination result, sets an adjusted search range to the search range setting unit, wherein
the search range adjustment unit
adjusts a lower limit of the second divided search range related to the plurality of first divided determination sections to a lower range, when the estimated value variation range exists within a fifth threshold value section on a lower limit side of the plurality of first divided determination sections, and
adjusts an upper limit of the second divided search range related to the plurality of first divided determination sections to a higher range, when the estimated value variation range exists within a sixth threshold value section on an upper limit side of the plurality of first divided determination sections.

14. The available bandwidth measuring system according to claim 10, wherein,
when resolution of the search range exceeds a predetermined threshold value,
the determination unit
shifts a next search range to a higher side or a lower side, and searches for the available bandwidth.

15. The available bandwidth measuring system according to claim 7, wherein
the determination unit
makes a change of the search range, and the available bandwidth determination, in accordance with a maximum value of the estimated values stored in the estimated value storage unit.

16. The available bandwidth measuring system according to claim 7, wherein
the determination unit
makes a change of the search range, and the available bandwidth determination, in accordance with a mean value, a median value, or a minimum value of the estimated values stored in the estimated value storage unit.

17. The available bandwidth measuring system according to claim 7, wherein
the estimated value variation range calculation unit
calculates a bandwidth range represented by a maximum value and a minimum value of the estimated values stored in the estimated value storage unit as an estimated value variation range.

18. The available bandwidth measuring system according to claim 1, further comprising
a search history storage unit caused by the determination unit to store time information when the available bandwidth is determined, determination information of the available bandwidth, and setting information of a search range in which the available bandwidth is determined, as search history information, wherein
the determination unit sets the first search range and the first determination section in accordance with the search history information.

19. The available bandwidth measuring system according to claim 18, wherein,
when the search history storage unit does not store the search history information, or when a predetermined time elapses from storage of the search history information,
the determination unit
searches a search range before division for the available bandwidth, the search range before division being defined as the first search range with an upper limit and a lower limit thereof being an upper limit and a lower limit of a physical bandwidth of a network being a target of a search for the available bandwidth.

20. The available bandwidth measuring system according to claim 19, wherein,
when the search history storage unit stores the search history information and a time elapsed from storage of the search history information is within a predetermined time,
the determination unit
sets the first search range in accordance with the setting information.

21. The available bandwidth measuring system according to claim 18, wherein
the search range adjustment unit
causes the search history storage unit to store the search history information added with adjustment information of the search range, and,
when the search history information stored in the search history storage unit includes the adjustment information,
the determination unit
sets the first search range in accordance with the adjustment information.

22. An available bandwidth measuring method comprising:
setting a first search range provided with a first determination section determining whether or not to change the first search range searched for an available bandwidth to a second search range;
generating a packet train including a plurality of measurement packets having successively increasing packet sizes, in accordance with the first search range, and transmitting the plurality of measurement packets at predetermined transmission intervals;
receiving the packet train and measuring reception intervals of the plurality of measurement packets;
calculating an estimated value of the available bandwidth in accordance with the packet sizes and a measurement result of the reception intervals of the plurality of measurement packets, and outputting the estimated value; and
determining whether or not to change the first search range to the second search range, in accordance with the first determination section and the estimated value, and, in accordance with a determination result, setting a change to the second search range and continuing searching for the available bandwidth, or making an available bandwidth determination of determining the estimated value to be the available bandwidth.

23. A transmission side device comprising:
a search range setting unit to which a first search range provided with a first determination section determining whether or not to change the first search range searched for an available bandwidth to a second search range is set;
a packet transmission unit that generates a packet train including a plurality of measurement packets having successively increasing packet sizes, in accordance with the first search range, and transmits the plurality of measurement packets at predetermined transmission intervals; and
a determination unit that
receives the packet train,
measures reception intervals of the plurality of measurement packets,
calculates an estimated value of the available bandwidth in accordance with the packet sizes and a measurement result of the reception intervals of the plurality of measurement packets,
determines whether or not to change the first search range to the second search range, in accordance with the output estimated value and the first determination section, and,
in accordance with a determination result,
sets a change to the second search range, to the search range setting unit, and continues searching for the available bandwidth, or
makes an available bandwidth determination of determining the estimated value to be the available bandwidth.

24. A receiving side device comprising:
a reception interval measurement unit that receives, when a packet train including a plurality of measurement packets having successively increasing packet sizes is generated in accordance with a first search range searched for an available bandwidth, the packet train in which the plurality of measurement packets are transmitted at predetermined transmission intervals, and measures reception intervals of the plurality of measurement packets; and
an estimated value calculation unit that calculates an estimated value of the available bandwidth in accordance with the packet sizes and a measurement result of the reception intervals of the plurality of measurement packets, and outputs the estimated value.

25. A storage medium storing a transmission side device control program that causes a computer included in a transmission side device to operate as:
a search range setting unit to which a first search range provided with a first determination section determining whether or not to change the first search range searched for an available bandwidth to a second search range is set;
a packet transmission unit that generates a packet train including a plurality of measurement packets having successively increasing packet sizes, in accordance with the first search range, and transmits the plurality of measurement packets at predetermined transmission intervals; and
a determination unit that
receives the packet train,
measures reception intervals of the plurality of measurement packets,
calculates an estimated value of the available bandwidth in accordance with the packet sizes and a measurement result of the reception intervals of the plurality of measurement packets,
determines whether or not to change the first search range to the second search range, in accordance with the output estimated value and the first determination section, and,
in accordance with a determination result,
sets a change to the second search range, to the search range setting unit, and continues searching for the available bandwidth, or
makes an available bandwidth determination of determining the estimated value to be the available bandwidth.

26. A storage medium storing a receiving side device control program causing a computer included in a receiving side device to operate as:
a reception interval measurement unit that receives, when a packet train including a plurality of measurement packets having successively increasing packet sizes is generated in accordance with a first search range searched for an available bandwidth, the packet train in which the plurality of measurement packets are transmitted at predetermined transmission intervals, and measures reception intervals of the plurality of measurement packets; and
an estimated value calculation unit that calculates an estimated value of the available bandwidth in accordance with the packet sizes and a measurement result of the reception intervals of the plurality of measurement packets, and outputs the estimated value.
